(19) United States
(12) Patent Application Publication
(10) Pub. No.: US 2004/0138910 A1
(43) Pub. Date: Jul. 15, 2004

(54) Service providing apparatus, service providing method and computer-readable storage medium

(76) Inventors: Yohichiroh Matsuno, Kanagawa (JP); Satosi Imago, Kanagawa (JP); Katsumi Kanasaki, Tokyo (JP); Yohei Yamamoto, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/694,868

(22) Filed: Oct. 29, 2003

(30) Foreign Application Priority Data
Oct. 30, 2002 (JP) 2002-315665
Oct. 6, 2003 (JP) 2003-346730
Oct. 6, 2003 (JP) 2003-346731

(51) Int. Cl. G06F 17/60

(52) U.S. Cl. 705/1

(57) ABSTRACT

A service providing apparatus includes a service providing section to provide services. The service providing section has an authentication information managing section to manage authentication information related to the services and having a term of validity, an extension request accepting section to accept an extension request to extend the term of validity of the authentication information, and an authentication information updating section to extend the term of validity of the authentication information depending on the extension request.

### BACKGROUND OF THE INVENTION

This application claims the benefit of Japanese Patent Applications No.2002-315665 filed Oct. 30, 2002, No.2003-346730 filed Oct. 6, 2003 and No.2003-346731 filed Oct. 6, 2003, in the Japanese Patent Office, the disclosure of which is hereby incorporated by reference.

1. Field of the Invention

The present invention generally relates to service providing apparatuses, service providing methods and computer-readable storage media, and more particularly to a service providing apparatus and a service providing method for providing various services, and to a computer-readable storage medium which stores a computer program for causing a computer to provide various services.

2. Description of the Related Art

According to the conventional World Wide Web (WWW) services, each service company (or provider) has its own “homepage” and provides a “closed” service on the homepage. On the homepage, a user can receive only the services provided by the service company which provides the homepage. If the user wishes to receive a service provided by another service company, the user must specify a Uniform Resource Locator (URL) of this other service company and move to the home page which is provided by this other service company.

Recently, “Web services” are becoming more popular. Various services on the Web are distributed as “components”, and the Web services are realized by combining such components.

In such a distributed-component environment, a communication between the components is often made by making a data conversion in an Extensible Markup Language (XML), using a Simple Object Access Protocol (SOAP) as the data accessing protocol, and using a HyperText Transfer Protocol (HTTP) as a low-layer protocol.

By employing the above described mechanism, the public Web services on the Internet can be mutually linked to make exchanges between Web services as one application, without human intervention.

For example, when providing a Web service which prints and distributes pay-contents, it is possible to improve the developing efficiency if existing accounting services and existing distribution services can be utilized.

When the HTTP is used as the communication protocol, it is possible to communicate with companies using a firewall, and the security can be improved using the Secure Sockets Layer (SSL).

However, due to the relatively slow transmission rate on the Internet, the response time (overhead) becomes a problem when a large amount of data is transmitted and received.

For this reason, a method has been proposed to solve the problem of increased overhead by using a ticket which certifies the authentication, authority and the like of the user. By enciphering this ticket and transmitting the enciphered ticket on the network, it is possible to reduce the amount of data transmitted on the network.

If privacy information such as personal information and secret information is frequency transmitted on the network, there is a possibility of impersonating, tampering, tapping and the like. However, it is possible to suppress leaking of the privacy information to a minimum by using the ticket.

For example, a Japanese Patent No.3,218,107 proposes a file printing method, a network system, a computer system, a file server and a print server which operate as follows.

(1) An authority is requested from a client system to a file source.

(2) The file source creates a certificate restante (ticket) which includes an identification name of the file source, a path to the file and the like, and returns the ticket to the client system.

(3) The client system sends the ticket to the print server and requests printing.

(4) The print server requests the file directly to the file source, using the identification name of the file source and the path to the file which are included within the ticket.

(5) The file source sends the file directly to the print server by confirming the contents of the ticket if the request is valid.

(6) The print server prints the contents of the received file.

By issuing, from the file source, the ticket which transfers the authority to operate on the file in the file source, it is possible to reduce the frequency at which the private information transmitted on the network. Furthermore, it becomes unnecessary to transfer the file twice, that is, first downloading the file from the file source to the client system and then requesting uploading and printing of the file from the client system to the print server. As a result, it is possible to reduce the number of unnecessary data transfer and unnecessary operations on the file.

In addition, when linking a plurality of Web services distributed on the network, it is possible to employ the Single-Sign-On. According to the Single-Sign-On, once a user authentication is made by an authentication server which centrally makes the authentications, it is possible to thereafter receive various services which require the user authentication.

For example, if a file server and a mail server provide mutually independent services, the user authentication must be made by the file server in order to receive the services provided by the file server, and the user authentication must be made by the mail server in order to receive the services provided by the file server. If the services of the file server and the mail server are receivable by the Single-Sign-On, the user can receive the services of the file server and the mail server once the user authentication is made by the authentication server.

As described above, the ticket is used to certify that the ticket holder (user) has been authenticated. However, if a term of validity can be extended, for example, the ticket may be used indefinitely if stolen by an unauthorized person. Because it is essential to protect the services from unauthorized use, the term of validity of the ticket is set short in most cases for the purpose of security.

But in a case where the processes related to the Web service take a longer time than anticipated, the ticket may become expired before the processes are completed. In a worst case, the user may not be able to receive the requested service and complete the desired processes.

It the ticket expires before the processes related to the Web service are completed, it becomes necessary to extend the term of validity of the ticket. But as described above, security measures must be taken to prevent unauthorized use of the extended ticket even when the extended ticket leaks.

The Japanese Patent No.3,218,107 fails to teach or suggest countermeasures for situations where the ticket expires because the user does not use the ticket for a long time after receiving the ticket or, the file source or the print server fails or, the power of the file source or the print server is turned OFF.

Countermeasures for such situations are proposed in a Japanese Patent Publication P2002-501218A. According to the proposed countermeasures, public-private key pairs and certificate templates are generated and stored in a key distribution center (KDC), and when the user request authentication with respect to the KDC, the KDC generates and signs a short-lived certificate, so as to recertify the user's public key.

However, when using the short-lived certificate which has expired, there was a problem in that the user must recertify the short-lived certificate each time. In addition, if the Web service is received by the Single-Sign-On, it is impossible to obtain the advantageous effects of the Single-Sign-On.

### SUMMARY OF THE INVENTION

Accordingly, it is a general object of the present invention to provide a novel and useful service providing apparatus, service providing method and computer-readable storage medium, in which the problems described above are eliminated.

Another and more specific object of the present invention is to provide a service providing apparatus, a service providing method and a computer-readable storage medium which can easily extend a term of validity of a ticket while maintaining security.

Still another and more specific object of the present invention is to provide a service providing apparatus comprising a service providing section to provide services, the service providing section comprising an authentication information managing section to manage authentication information related to the services and having a term of validity; an extension request accepting section to accept an extension request to extend the term of validity of the authentication information; and an authentication information updating section to extend the term of validity of the authentication information depending on the extension request. According to the service providing apparatus of the present invention, it is possible to easily extend the term of validity of the authentication information, while maintaining security.

As will be described later, the service providing section may correspond to a user authentication service SA or a contents storage service SB. The authentication information managing section may correspond to a ticket storage section 40. In addition, the extension request accepting section may correspond to a Web service interface (I/F) 10 and/or a request processing section 20. The authentication information updating section may correspond to a ticket updating section 50. The authentication information may correspond to an authentication ticket, a print ticket or the like.

A further object of the present invention is to provide a service providing method to provide services, comprising an authentication information managing step to manage authentication information related to the services and having a term of validity; an extension request accepting step to accept an extension request to extend the term of validity of the authentication information; and an authentication information updating step to extend the term of validity of the authentication information depending on the extension request. According to the service providing method of the present invention, it is possible to easily extend the term of validity of the authentication information, while maintaining security.

Another object of the present invention is to provide a computer-readable storage medium which stores a program for causing a computer to provide services, the program comprising an authentication information managing procedure causing the computer to manage authentication information related to the services and having a term of validity; an extension request accepting procedure causing the computer to accept an extension request to extend the term of validity of the authentication information; and an authentication information updating procedure causing the computer to extend the term of validity of the authentication information depending on the extension request. According to the computer-readable storage medium of the present invention, it is possible to easily extend the term of validity of the authentication information, while maintaining security.

Still another object of the present invention is to provide a service providing apparatus comprising an integrated services providing section to provide one or a plurality of services provided by a service providing section, the integrated services providing section comprising a creating request sending section to send an authentication information creating request requesting creation of authentication information which has a term of validity and is related to a service provided by a first service providing section within the service providing section, with respect to the first service providing section; a response receiving section to receive from the first service providing section an authentication information creation response including an identifier for identifying the authentication information and the term of validity of the authentication information; and an extension request sending section to send an extension request requesting extension of the term of validity of the authentication information, with respect to the first service providing section. According to the service providing apparatus of the present invention, it is possible to easily extend the term of validity of the authentication information, while maintaining security.

As will be described later, the integrated services providing section may correspond to a portal site 2. The first service providing section may correspond to a user authentication service SA. In addition, the authentication information may correspond to an authentication ticket, a print ticket or the like.

A further object of the present invention is to provide a service providing method for an integrated services providing section which provides integrated services of one or a plurality of services provided by a service providing section, comprising a creating request sending step to send an authentication information creating request requesting creation of authentication information which has a term of validity and is related to a service provided by a first service providing section within the service providing section, with respect to the first service providing section; a response receiving step to receive from the first service providing section an authentication information creation response including an authentication information identifier for identifying the authentication information and the term of validity of the authentication information; and an extension request sending step to send an extension request requesting extension of the term of validity of the authentication information, with respect to the first service providing section. According to the service providing method of the present invention, it is possible to easily extend the term of validity of the authentication information, while maintaining security.

Another object of the present invention is to provide a computer-readable storage medium which stores a program for causing a computer to provide integrated services of one or a plurality of services provided by a service providing section, comprising a creating request sending procedure causing the computer to send an authentication information creating request requesting creation of authentication information which has a term of validity and is related to a service provided by a first service providing section within the service providing section, with respect to the first service providing section; a response receiving procedure causing the computer to receive from the first service providing section an authentication information creation response including an authentication information identifier for identifying the authentication information and the term of validity of the authentication information; and an extension request sending procedure causing the computer to send an extension request requesting extension of the term of validity of the authentication information, with respect to the first service providing section. According to the computer-readable storage medium of the present invention, it is possible to easily extend the term of validity of the authentication information, while maintaining security.

Other objects and further features of the present invention will be apparent from the following detailed description when read in conjunction with the accompanying drawings.

### BRIEF DESCRIPTION OF THE DRAWINGS

FIG. 1 is a diagram for explaining a marketing service which sells pay-contents;

FIG. 2 is a diagram showing a hardware structure of a first embodiment of a service providing apparatus according to the present invention;

FIG. 3 is a diagram for explaining a functional structure of a service forming a pay-contents marketing service;

FIG. 4 is a diagram showing a data structure of a client list;

FIG. 5 is a diagram showing a data structure of a ticket of the first embodiment;

FIG. 6 is a diagram showing a data structure within a ticket storage section of the first embodiment;

FIG. 7 is a flow chart for explaining a process of extending a term of validity of the ticket in the first embodiment;

FIG. 8 is a flow chart for explaining a service providing process of the first embodiment;

FIG. 9 is a diagram showing a data structure within a ticket storage section in a second embodiment;

FIG. 10 is a flow chart for explaining a process of extending a term of validity of the ticket in the second embodiment;

FIG. 11 is a flow chart for explaining a service providing process of the second embodiment;

FIG. 12 is a diagram showing a data structure of a ticket of a third embodiment;

FIG. 13 is a flow chart for explaining a process of extending a term of validity of the ticket in the third embodiment;

FIG. 14 is a diagram showing a data structure of the ticket storage section in a fourth embodiment when applied to the first embodiment;

FIG. 15 is a diagram showing a data structure of the ticket storage section in the fourth embodiment when applied to the second embodiment;

FIG. 16 is a diagram showing a data structure of a ticket in the fourth embodiment;

FIG. 17 is a flow chart for explaining a process of extending a term of validity of the ticket of the fourth embodiment;

FIG. 18 is a diagram showing a data structure of a ticket in a modification of the fourth embodiment;

FIG. 19 is a diagram for explaining another functional structure of the service forming the pay-contents marketing service;

FIG. 20 is a flow chart for explaining a notification process related to extending a term of validity of the ticket of the fifth embodiment;

FIG. 21 is a sequence diagram for explaining a sixth embodiment;

FIG. 22 is a diagram showing a data structure of a session in the sixth embodiment;

FIG. 23 is a diagram for explaining a functional structure of the service forming a portal site;

FIG. 24 is a diagram showing a data structure of a ticket information managing section in the sixth embodiment;

FIG. 25 is a flow chart for explaining an authentication ticket creating request process of the portal site in the sixth embodiment;

FIG. 26 is a flow chart for explaining a session creating request process of the portal site in the sixth embodiment;

FIG. 27 is a flow chart for explaining an extension request process of the portal site in the sixth embodiment;

FIG. 28 is a sequence diagram for explaining a seventh embodiment;

FIG. 29 is a diagram for explaining another functional structure of the service forming the portal site; and

FIG. 30 is a flow chart for explaining an extension request process of the portal site in the seventh embodiment.

### DESCRIPTION OF THE PREFERRED EMBODIMENTS

A description will be given of various embodiments of a service providing apparatus according to the present invention, a service providing method according to the present invention, and a compute-readable storage medium according to the present invention, by referring to the drawings.

[First Embodiment]

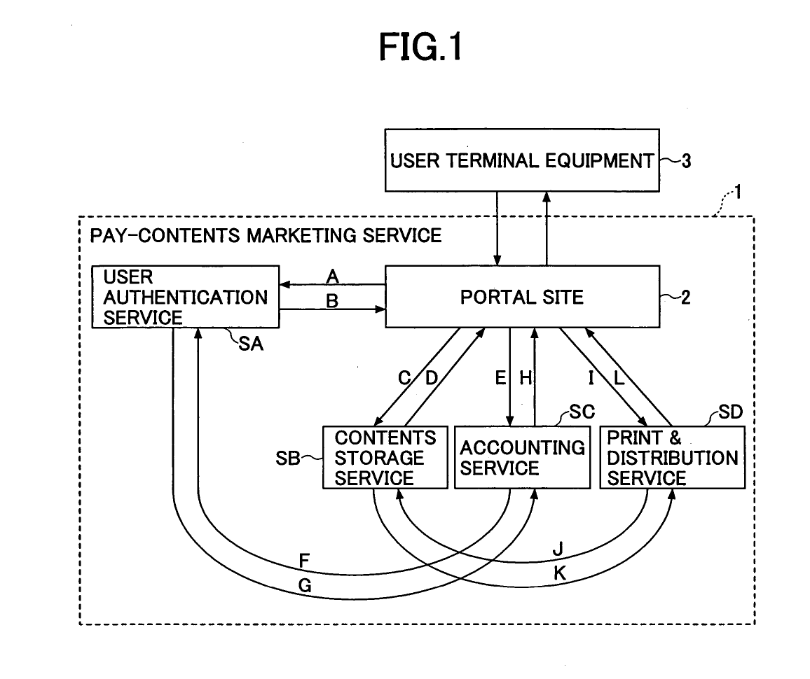

A first embodiment of the present invention will be described with reference to FIG. 1, for a case where marketing services (Web services) 1 sell pay-contents. FIG. 1 is a diagram for explaining the marketing services 1 which sell the pay-contents (hereinafter simply referred to as pay-contents marketing services).

The pay-contents marketing services 1 shown in FIG. 1 include a portal site 2, a user authentication service SA, a plurality of contents storage services SB which store pay-contents, an accounting service SC to make the accounting when pay-contents are purchased, and a print and distribution service SD to print and/or distribute the purchased pay-contents.

Generally, each service is formed by a software which runs on a computer system and realizes the functions of the service. Each service may be included in a single service providing apparatus or, distributed and included in a plurality of service providing apparatuses.

The pay-contents marketing service operates in the following manner, so that the user may purchase the pay-contents.

(P1) The user makes a log-in to the portal site 2 from a user terminal equipment 3, by inputting the user name, password and the like of the user.

(P2) The portal site 2 requests the user authentication service SA to make a user authentication based on the user name and the password, as indicated by A in FIG. 1. The portal site 2 may temporarily hold the user name and the password, so that when a term of validity of an authentication ticket (authentication information) which will be described expires, for example, the portal site 2 may request the user authentication again to the user authentication service SA.

(P3) The user authentication service SA refers to a user registration file which registers the user name, the password and the like, and creates an authentication ticket which certifies the user authentication if the combination of the user name and password is correct. The user authentication service SA returns an authentication ticket ID for identifying the authentication ticket, to the portal site 2, as indicated by B in FIG. 1. The portal site 2 holds the authentication ticket ID acquired from the user authentication service SA, and is capable of making a session with the services SB, SB and SC, for example, using the authentication ticket ID.

(P4) When the user authentication is made, the user searches for the pay-contents to be purchased, from among the pay-contents registered in the portal site 2. When the user determines the pay-contents to be purchased and requests printing of the purchased pay-contents, the portal site 2 requests a print ticket certifying a print authority of the purchased pay-contents, with respect to the corresponding contents storage service SB, for example, as indicated by C in FIG. 1. The contents storage service SB confirms whether or not the portal site 2 has the print authority, and creates the print ticket if the portal site 2 has the print authority. The contents storage service SB returns a print ticket ID for identifying the print ticket, to the portal site 2, as indicated by D in FIG. 1.

(P5) If the user has the print authority, the portal site 2 requests accounting of the charges to the accounting service SC, by sending an accounting method specified by the user and the authentication ticket ID to the accounting service SC, as indicated by E in FIG. 1. The accounting service SC makes a user confirmation using the authentication ticket ID by making an inquiry to the user authentication service SA, as indicated by F and G in FIG. 1, and returns an accounting result to the portal site 2, as indicated by H in FIG. 1.

(P6) When the accounting is settled, the portal site 2 sends the print ticket ID to the print and distribution service SD and requests the printing and distribution of the purchased pay-contents, as indicated by I in FIG. 1. The print and distribution service SD sends the print ticket ID to the contents storage service SB and requests sending of the purchased pay-contents, as indicated by J in FIG. 1. The contents storage service SB confirms that the received print ticket ID (or the print ticket) is the print ticket ID (or print ticket) issued by this contents storage service SB, and sends the purchased pay-contents which are requested to the print and distribution service SD, as indicated by K in FIG. 1. Finally, the print and distribution service SD prints the purchased pay-contents received, and distributes the purchased pay-contents to the user. The print and distribution service SD returns a result of the printing and distribution to the portal site 2, as indicated by L in FIG. 1.

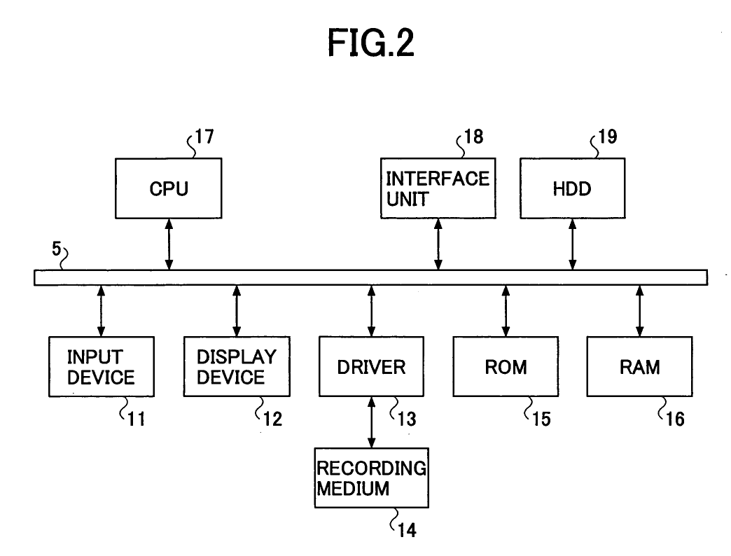

Next, a description will be given of a hardware structure of this first embodiment of the service providing apparatus, by referring to FIG. 2. FIG. 2 is a diagram showing the hardware structure of this first embodiment of the service providing apparatus.

The service providing apparatus shown in FIG. 2 includes an input device 11, a display device 12, a driver 13, a Read Only Memory (ROM) 15, a Random Access Memory (RAM) 16, a Central Processing Unit (CPU) 17, an interface unit 18, and a Hard Disk Drive (HDD) 19 which are connected via a bus 5. The driver 13 is adapted to drive a recording medium 14, so as to record information on and/or reproduce information from the recording medium 14.

The input device 11 is formed by a keyboard, a mouse or the like which is operated by the user of the service providing apparatus, to input various operation signals (that is, information, commands and the like) to the service providing apparatus. The display device 12 is formed by a display or the like which is used to display various information to the user of the service providing apparatus. The interface unit 18 provides an interface between the service providing apparatus and a network or the like to which the service providing apparatus connects.

Application programs corresponding to the services (for example, the user authentication service SA) and/or an application program corresponding to the portal site 2, a main program for controlling the entire operation of the service providing apparatus, and the like may be stored in the recording medium 14 such as a CD-ROM and provided to the service providing apparatus or, provided to the service providing apparatus by being downloaded from a computer or the like via the network. In the case where the application programs, the main program and the like described above are stored in the recording medium 14, the recording medium 14 is set in the driver 13 so that the application programs, the main program and the like may be installed in the ROM 15 via the driver 13.

The ROM 15 stores data in addition to the application programs, the main program and the like. The RAM 16 stores the application programs, the main program and the like which are read from the ROM 15 when the service providing apparatus is started. The CPU 17 carries out processes by executing the application programs, the main program and the like stored in the RAM 16.

The HDD 19 stores data, files and the like. For example, the HDD 19 stores tickets, client lists and the like.

As may be seen from FIG. 2, the service providing apparatus of the present invention may be realized by a general purpose computer, such as a personal computer. Of course, the basic structure of the computer forming the service providing apparatus is not limited to that shown in FIG. 2, and the service providing apparatus may be formed by any computer having a suitable basic structure. Further, the computer-readable storage medium of the present invention may be realized by any recording media capable of storing a computer program in a computer-readable manner, so that the computer which reads the computer program is caused to operate as the service providing apparatus to provide service according to the service providing method of the present invention.

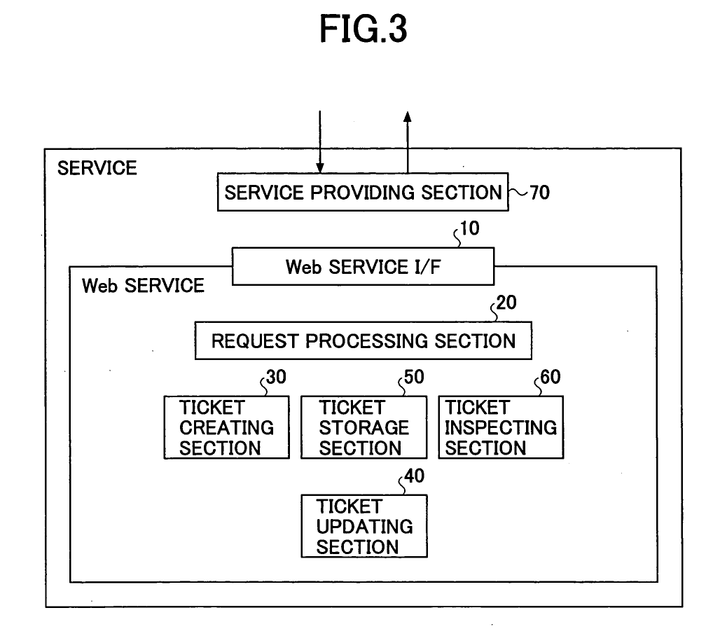

Next, a description will be given of a functional structure of a service forming a pay-contents marketing service, by referring to FIG. 3. FIG. 3 is a diagram for explaining the functional structure of the service forming the pay-contents marketing service in this first embodiment.

The service shown in FIG. 3 includes a service providing section 70, a Web service interface (I/F) 10, a request processor 20, a ticket creating section 30, a ticket storage section 40, a ticket updating section 50, and a ticket inspecting section 60.

The service providing section 70 receives requests from other services, such as the portal site 2 and the services SA, SB, SC and SD described above, and returns processed results of the requests to the corresponding services.

For example, the user authentication service SA carries out the service functions including user authentication requested from the portal site 2, returning of the authentication ticket (authentication ticket ID) certifying the user authentication to the portal site 2, and user confirmation requested from the various services.

The contents storage service SB carries out the service functions including search, content confirmation and the like from the portal site in correspondence with a contents inspection request from the user, print authority check and returning of the print ticket (print ticket ID) with respect to the contents from the portal site 2 in correspondence with a contents print request from the user, and transfer of the contents in response to inquiry of the print ticket from the print and distribution service SD.

When the service providing section 70 carries out a function, the Web service I/F 10 intermediates with key functions of the Web service.

If a request received from the service providing section 70 via the Web service I/F 10 requests ticket creation, the request processor 20 operates the ticket creating section 30. If the received request requests ticket updating, the request processor 20 operates the ticket updating section 50. Furthermore, if the received request requests ticket inspection, the request processor 20 operates the ticket inspecting section 60. The request processor 20 returns a result of operating the ticket creating section 30, the ticket updating section 50 or the ticket inspecting section 60 to the service providing section 70 via the Web service I/F 10.

The ticket creating section 30 creates a ticket requested from an other service, stores the created ticket in the ticket storage section 40, and uses the service providing section 70 to return the ticket ID and the term of validity of the ticket to the other service. In a case where the service of interest shown in FIG. 3 is the user authentication service SA, the other service may be any one of the portal site 2, the contents storage services SB, the accounting service SC and the print and distributing service SD. The other service will hereinafter be also referred to as a client.

The client makes a ticket creating request by specifying the following data.

(D1) Data Forming Basis of Ticket Creation

The data forming the basis of the ticket creation includes the user name, the password and the like in the case of the user authentication service SA. On the other hand, in the case of the contents storage service SB which stores contents including information, documents and/or images, the data forming the basis of the ticket creation includes an identifier which specifies a target content to be inspected, printed and/or transferred, and a session ID which identifies a session between a request source service and the contents storage service SB. The identifier indicates a file name, a path indicating a file and the like.

(D2) Term of Validity of Ticket

The term of validity of ticket specifies the term of validity of the ticket which is issued. If a value of the term of validity is not appropriate, the term of validity is corrected to a predetermined value. The term of validity is inspected by the ticket inspecting section 60, and a ticket having a term of validity which has expired can no longer be used.

(D3) List of Service Names Used By Client (IP Address, Host Name and Domain Name, etc.)

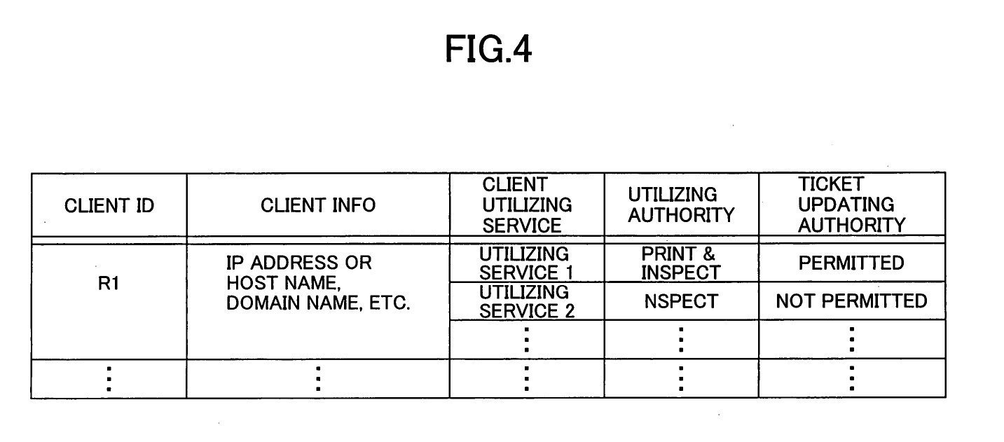

The ticket storage section 40 stores the following data with respect to the client, as a client list, and manages the data in correspondence with the ticket, as shown in FIG. 4 which will be described later.

a) Identifier (client ID) identifying the client;

b) Information (client information) specifying the client, such as client name, IP address, and host name and domain name; and

c) Service utilizing authority (for example, inspection, print and transfer) and authority to extend (update) term of validity of ticket, for each service to be utilized by client (client utilizing service).

For example, in a case where the service of interest is the user authentication service SA, one of the clients is the portal site 2, and the client utilizing services are the contents storage services SB, the accounting service SC, the print and distributing service SD and the like.

When the ticket creating section 30 receives the ticket creating request, the ticket creating section 30 may create the ticket by referring to the client list and checking the utilizing authority for each utilizing service of the client which is the source of the ticket creating request.

In a case where the service of interest is the contents storage service SB, and a ticket creating request to create a print ticket is received from the portal site 2 when the service name to be utilized by the client is the print and distributing service SD, the ticket creating section 30 may refer to the client list and judge whether or not the print and distributing service SD is included as the client utilizing service of the portal site 2. If the print and distributing service SD is included in the client list as the client utilizing service of the portal site 2, the ticket creating section 30 may refer to the service utilizing authority of the print and distributing service SD, and create the print ticket depending on the service utilizing authority. For example, the print ticket may be created depending on the service utilizing authority, so as to permit the printing and inspection of the contents.

FIG. 4 is a diagram showing a data structure of the client list in this first embodiment. FIG. 4 shows the client list which is managed in the ticket storage section 40 of the contents storage service SB.

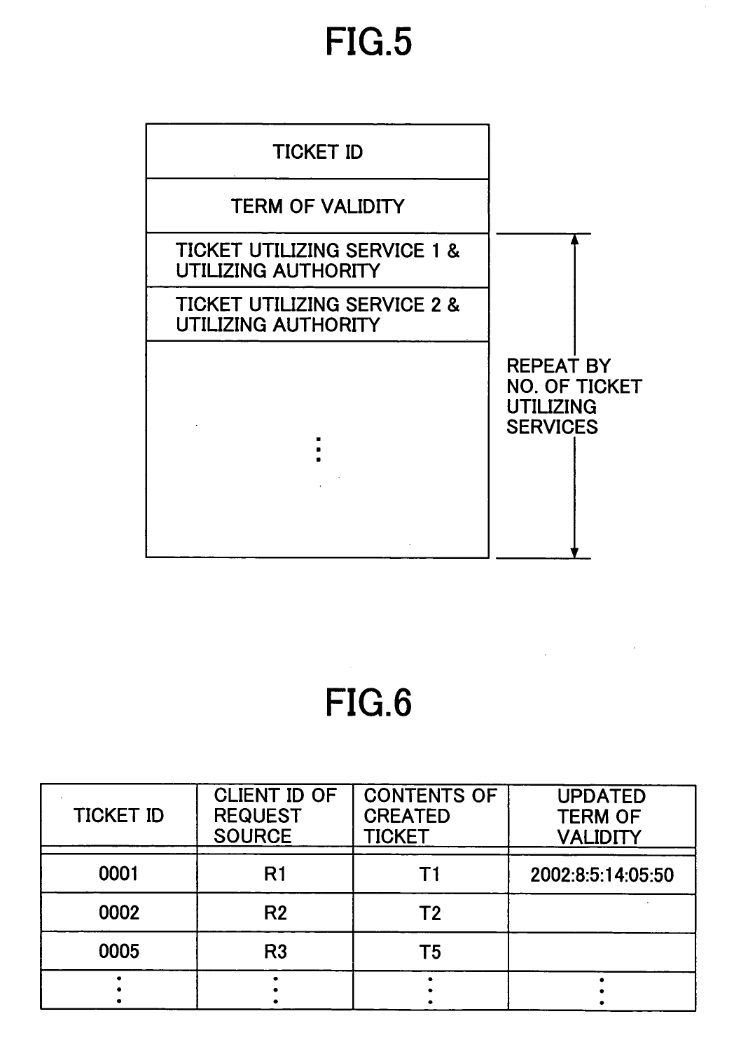

The ticket which is created has a data structure shown in FIG. 5. FIG. 5 is a diagram showing a data structure of the ticket in this first embodiment. As shown in FIG. 5, the created ticket includes a ticket ID for identifying the ticket, a term of validity, and a list of ticket utilizing services and utilizing authorities of the ticket utilizing services. For example, the ticket utilizing service includes the client utilizing service and/or the client ID or the client information shown in FIG. 4.

The ticket creating section 30 adds the ticket ID to the created ticket, registers the ticket and the ticket ID in the ticket storage section 40, and returns the ticket ID and the term of validity of the ticket to the client.

The ticket storage section stores the identifier of the client (client ID) and the contents of the created ticket, in relation to the ticket ID as shown in FIG. 6. FIG. 6 is a diagram showing a data structure within the ticket storage section 40 of this first embodiment. The data shown in FIG. 6 includes the ticket ID, the client ID of the request source, the contents of the created ticket, and the extended (updated) term of validity. Of course, the contents shown in FIG. 6 may be included in the ticket shown in FIG. 5.

The ticket updating section 50 checks the ticket storage section 40 based on the ticket ID and the client ID received from the client when an extension request to extend the term of validity is received, so as to determine whether or not the ticket has been issued by the service of interest. If the ticket has not been issued by the service of interest, the ticket updating section 50 returns to the client a message indicating that the extension request was unsuccessful (or unacceptable).

On the other hand, if the ticket has been issued by the service of interest, the ticket updating section 50 compares the term of validity included in the ticket corresponding to the ticket ID and the present time. The ticket updating section 50 returns to the client a message indicating that the extension request was unsuccessful, if the present time does not fall within the term of validity of the ticket.

If the present time falls within the term of validity of the ticket, the ticket updating section 50 refers to the client list, and checks whether or not the client which is the source of the extension request has the authority to update the ticket. If the client which is the source of the extension request does not have the authority to update the ticket, the ticket updating section 50 returns to the client a message indicating that the extension request was unsuccessful. On the other hand, if the client which is the source of the extension request has the authority to update the ticket, the ticket updating section 50 sets a term of validity which is extended by an extension time which is specified by the client or by an extension time which is preset, registers the new term of validity in the ticket storage section 40 as shown in FIG. 6, and returns the ticket ID and the updated term of validity of the ticket to the client.

The extension time which is preset may be determined depending on the level of security required by the service. For example, the extension time which is preset may be set in a definition file stored in the HDD 19 or the like, by a person in charge of managing the service which issues the ticket.

The client list shown in FIG. 4 includes information (client ID and client information) related to the client which made the ticket creating request. However, the client list may of course be formed so as not to include such information.

In the following description, it is assumed for the sake of convenience that the client which makes the ticket creating request has the authority to update the ticket.

When a service utilizing request is received, the ticket inspecting section 60 checks the ticket storage section 40 based on the ticket ID and the client ID received from the client which is the source of the service utilizing request, to determine whether or not the ticket has been issued by the service of interest. If the ticket has not been issued by the service of interest, the ticket inspecting section 60 returns to the client an error message indicating that the service utilizing request was unsuccessful.

On the other hand, if the ticket has been issued by the service of interest, the ticket inspecting section 60 compares the present time and the term of validity of the ticket included in the ticket which corresponds to the received ticket ID. If the present time does not fall within the term of validity, the ticket inspecting section 60 returns to the client an error message indicating that the service utilizing request was unsuccessful. In a case where the extended term of validity is set in the ticket storage section 40, the ticket inspecting section 60 compares the present time and the extended term of validity.

On the other hand, if the present time falls within the term of validity, the ticket inspecting section 60 acquires the service utilizing authority for the service which is requested by the service utilizing request from the client, and returns the service utilizing authority to the service providing section 70. The service providing section 70 carries out the processes of the requested service depending on the service utilizing authority.

In the case of the pay-contents marketing service, for example, the processes of the accounting service SC may take time after the portal site 2 receives the print ticket for the contents from the contents storage service SB, and result in the expiry of the term of validity of the print ticket before the print ticket is handed to the print and distribution service SD. This problem of expiry of the term of validity of the ticket may be solved by making an extension request to extend (or update) the term of validity of the print ticket from the portal site 2 to the contents storage service SB after the contents storage service SB returns a response or during the processing of the accounting service SC.

By forming the services in the above described manner, it is possible to restrict the clients which may extend the term of validity of the ticket, to thereby restrict the ticket from being updated by clients other than the clients originally intended to permit extension of the term of validity of the ticket.

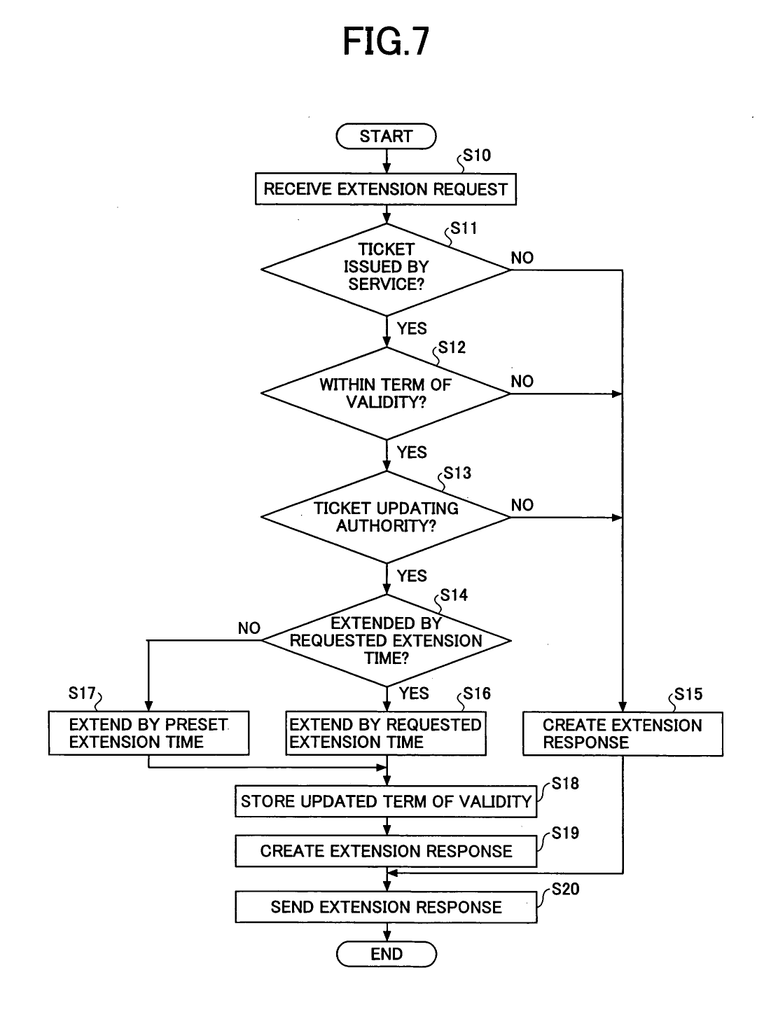

Next, a description will be given of a process of extending the term of validity of the ticket in this first embodiment, by referring to FIG. 7. FIG. 7 is a flow chart for explaining the process of extending the term of validity of the ticket in this first embodiment. In the following description of FIG. 7, it is assumed for the sake of convenience that the term of validity of the ticket is extended by the contents storage service SB, that is, the processes shown in FIG. 7 are carried out by the contents storage service SB.

In a step S10 shown in FIG. 7, the contents storage service SB receives an extension request to extend the term of validity of a print ticket from the portal site 2, for example. In a step S11, the contents storage service SB decides whether or not the print ticket has been issued by the contents storage service SB, by referring to the data stored in the ticket storage section 40 as shown in FIG. 6, based on a print ticket ID and a client ID identifying the portal site 2 which are included in the extension request received in the step S10. The process advances to a step S12 if the decision result in the step S11 is YES, and the process advances to a step S15 which will be described later if the decision result in the step S11 is NO.

In the step S12, the contents storage service SB decides whether or not the present time falls within the term of validity of the print ticket, by comparing the present time and the term of validity of the print ticket included in the print ticket corresponding to the print ticket ID. The process advances to a step S13 if the decision result in the step S12 is YES, and the process advances to the step S15 if the decision result in the step S12 is NO. If the extended term of validity is set in the ticket storage section 40, the contents storage service SB compares the present time and the extended term of validity.

In the step S13, the contents storage service SB decides whether or not the portal site 2 which is the source of the extension request has the authority to update the print ticket, by referring to the client list shown in FIG. 4. The process advances to a step S14 if the decision result in the step S13 is YES, and the process advances to the step S15 if the decision result in the step S13 is NO.

In the step S14, the contents storage service SB decides whether or not to extend the term of validity of the print ticket by an extension time which is requested by the portal site 2 and included in the extension request to extend the term of validity of the print ticket received in the step S10. The process advances to a step S16 if the decision result in the step S14 is YES, and the process advances to a step S17 if the term of validity of the print ticket is to be extended by an extension time which is preset and the decision result in the step S14 is NO. For example, the contents storage service SB decides whether to extend the term of validity by the requested extension time or by the preset extension time, by referring to a flag or the like which is defined in the definition file stored in the HDD 19 or the like.

In the step S15, the contents storage service SB creates an extension response (or message) including information which indicates that the extension request was unsuccessful. In the step S16, the contents storage service SB extends the term of validity of the print ticket corresponding to the print ticket ID by the requested extension time. In the step S17, the contents storage service SB extends the term of validity of the print ticket corresponding to the print ticket ID by the preset extension time. The process advances to a step S18 after the step S16 or S17.

In the step S18, the contents storage service SB stores the extended term of validity (updated term of validity) which has been extended by the step S16 or S17 into the ticket storage section 40. Then, in a step S19, the contents storage service SB creates an extension response including information which indicates that the extension request was successful, the print ticket ID and the extended term of validity (updated term of validity). In a step S20, the contents storage service SB sends the extension response which is created by the step S15 or S19 to the portal site 2 which is the source of the extension request.

By carrying out the processes shown in FIG. 7, the service can extend the term of validity of the ticket in response to the extension request from the client which has the authority to extend the term of validity of the concerned ticket.

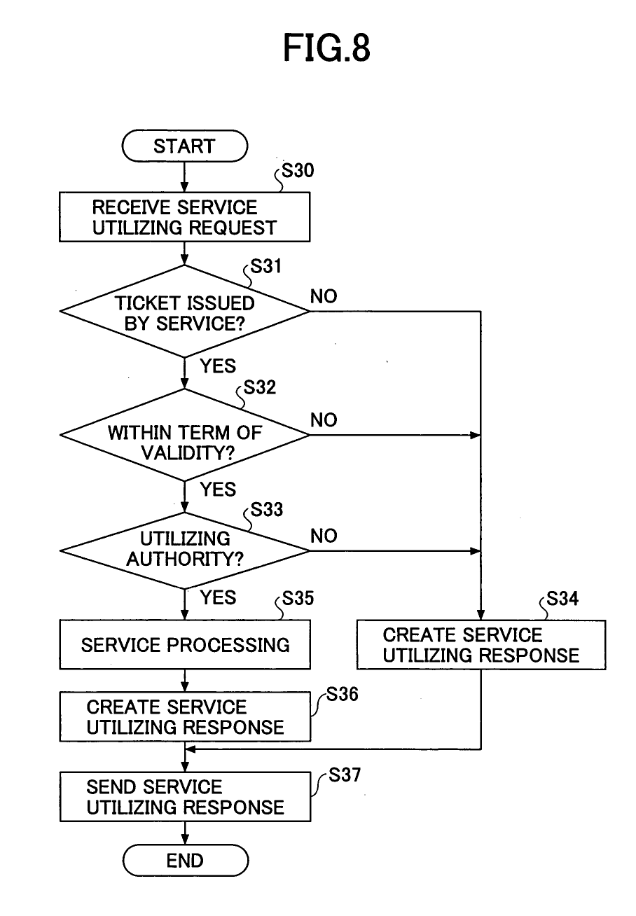

Next, a description will be given of a service providing process of this first embodiment, by referring to FIG. 8. FIG. 8 is a flow chart for explaining the service providing process of this first embodiment. In the following description of FIG. 8, it is assumed for the sake of convenience that the service producing process is carried out by the contents storage service SB, that is, the processes shown in FIG. 8 are carried out by the contents storage service SB.

In a step S30 shown in FIG. 8, the contents storage service SB receives a service utilizing request for the contents storage service SB from the print and distribution service SD. In a step S31, the contents storage service SB decides whether or not the a print ticket has been issued from the contents storage service SB by referring to the data in the ticket storage section 40 shown in FIG. 6, based on a print ticket ID and a client ID identifying the print and distribution service SD which are included in the service utilizing request received in the step S30. The process advances to a step S32 if the decision result in the step S31 is YES, and the process advances to a step S34 which will be described later if the decision result in the step S31 is NO.

In the step S32, the contents storage service SB decides whether or not the present time falls within a term of validity of the print ticket, by comparing the present time and the term of validity of the print ticket included in the print ticket corresponding to the print ticket ID. The process advances to a step S33 if the decision result in the step S32 is YES, and the process advances to the step S34 if the decision result in the step S32 is NO. If the extended term of validity is set in the ticket storage section 40, the contents storage service SB compares the present time and the extended term of validity.

In the step S33, the contents storage service SB decides whether or not the print and distribution service SD has the authority to acquire the contents, for example, by referring to the client list shown in FIG. 4, based on the client ID for identifying the print and distribution service SD and a service utilizing type (for example, acquisition of the contents) which are included in the service utilizing request received in the step S30. The process advances to a step S35 if the decision result in the step S33 is YES, and the process advances to the step S34 if the decision result in the step S33 is NO.

In the step S34, the contents storage service SB creates a service utilizing response including information which indicates that the service utilizing request was unsuccessful. In the step S35, the contents storage service SB carries out the processes for providing the service requested by the print and distribution service SD, such as the process of acquiring the corresponding contents from the contents which are stored and managed by the contents storage service SB.

In a step S36 after the step S35, the contents storage service SB creates a service utilizing response including information which indicates that the service utilizing request was successful and the contents acquired in the step S35, for example. After the step S34 or S36, the process advances to a step S37. In the step S37, the contents storage service SB sends the service utilizing response created in the step S34 or S36 to the print and distribution service SD which is the source of the service utilizing request received in the step S30.

By carrying out the processes shown in FIG. 8, the service can provide the requested service depending on the service utilizing request from the client which has the service utilizing authority.

[Second Embodiment]

According to the first embodiment described above, the term of validity of the ticket is simply extended. For this reason, the ticket having the extended (updated) term of validity may be abused by an unauthorized person if stolen.

Hence, in this second embodiment, the present ticket is discarded and a new ticket is issued when an extension request is received to extend the term of validity of the present ticket.

A functional structure of the service forming the pay-contents marketing service in this second embodiment includes a service providing section 70, a Web service interface (I/F) 10, a request processor 20, a ticket creating section 30, a ticket storage section 40, a ticket updating section 50, and a ticket inspecting section 60, similarly to the functional structure shown in FIG. 3. Hence, a description will only be given with respect to parts of this second embodiment which differ from those of the first embodiment described above.

The ticket updating section 50 checks the ticket storage section 40 based on a ticket ID and a client ID received from the client when an extension request to extend the term of validity is received, so as to determine whether or not the ticket has been issued by the service of interest. If the ticket has not been issued by the service of interest, the ticket updating section 50 returns to the client a message indicating that the extension request was unsuccessful (or unacceptable).

On the other hand, if the ticket has been issued by the service of interest, the ticket updating section 50 compares the term of validity included in the ticket corresponding to the ticket ID and the present time. The ticket updating section 50 returns to the client a message indicating that the extension request was unsuccessful, if the present time does not fall within the term of validity of the ticket.

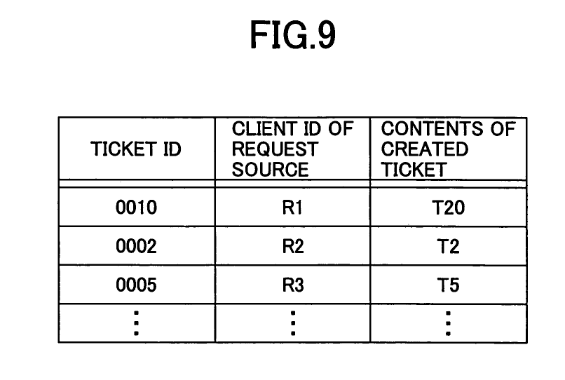

If the present time falls within the term of validity of the ticket, the ticket updating section 50 refers to the client list, and checks whether or not the client which is the source of the extension request has the authority to update the ticket. If the client which is the source of the extension request does not have the authority to update the ticket, the ticket updating section 50 returns to the client a message indicating that the extension request was unsuccessful. On the other hand, if the client which is the source of the extension request has the authority to update the ticket, the ticket updating section 50 sets a term of validity which is extended by an extension time which is specified by the client or by an extension time which is preset, creates a new ticket having the new term of validity in the ticket storage section 40 as shown in FIG. 9, and returns the ticket ID of the newly created ticket and the updated term of validity of the new ticket to the client. FIG. 9 is a diagram showing a data structure within the ticket storage section 40 of this second embodiment. The data shown in FIG. 9 includes the ticket ID, the client ID of the request source, and the contents of the created ticket. The ticket updating section 50 deletes the old ticket from the ticket storage section 40.

Instead of deleting the old ticket, it is of course possible to set a flag indicating that the old flag is no longer usable. But for the sake of convenience, it is assumed in the following description that the old ticket is deleted from the ticket storage section 40.

When a service utilizing request is received, the ticket inspecting section 60 checks the ticket storage section 40 based on the ticket ID and the client ID received from the client which is the source of the service utilizing request, to determine whether or not the ticket has been issued by the service of interest. If the ticket has not been issued by the service of interest, the ticket inspecting section 60 returns to the client an error message indicating that the service utilizing request was unsuccessful.

On the other hand, if the ticket has been issued by the service of interest, the ticket inspecting section 60 compares the present time and the term of validity of the ticket included in the ticket which corresponds to the received ticket ID. If the present time does not fall within the term of validity, the ticket inspecting section 60 returns to the client an error message indicating that the service utilizing request was unsuccessful.

On the other hand, if the present time falls within the term of validity, the ticket inspecting section 60 acquires the service utilizing authority for the service which is requested by the service utilizing request from the client, and returns the service utilizing authority to the service providing section 70. The service providing section 70 carries out the processes of the requested service depending on the service utilizing authority.

By forming the services in the above described manner, it is possible to extend the term of validity of the ticket by creating the new ticket so that the old ticket can no longer be used after the term of validity is extended, even if the old ticket is stolen before the term of validity is extended.

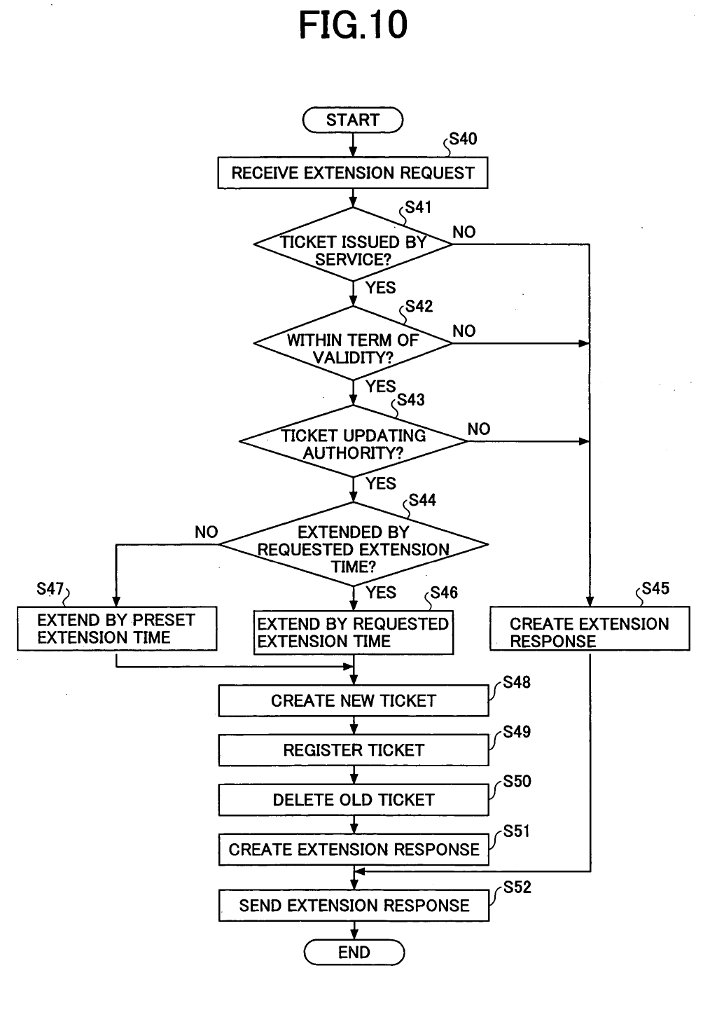

Next, a description will be given of a process of extending the term of validity of the ticket in this second embodiment, by referring to FIG. 10. FIG. 10 is a flow chart for explaining the process of extending the term of validity of the ticket in this second embodiment. In the following description of FIG. 10, it is assumed for the sake of convenience that the term of validity of the ticket is extended by the contents storage service SB, that is, the processes shown in FIG. 10 are carried out by the contents storage service SB.

In a step S40 shown in FIG. 10, the contents storage service SB receives an extension request to extend the term of validity of a print ticket from the portal site 2, for example. In a step S41, the contents storage service SB decides whether or not the print ticket has been issued by the contents storage service SB, by referring to the data stored in the ticket storage section 40 as shown in FIG. 9, based on a print ticket ID and a client ID identifying the portal site 2 which are included in the extension request received in the step S40. The process advances to a step S42 if the decision result in the step S41 is YES, and the process advances to a step S45 which will be described later if the decision result in the step S41 is NO.

In the step S42, the contents storage service SB decides whether or not the present time falls within the term of validity of the print ticket, by comparing the present time and the term of validity of the print ticket included in the print ticket corresponding to the print ticket ID. The process advances to a step S43 if the decision result in the step S42 is YES, and the process advances to the step S45 if the decision result in the step S42 is NO.

In the step S43, the contents storage service SB decides whether or not the portal site 2 which is the source of the extension request has the authority to update the print ticket, by referring to the client list shown in FIG. 4. The process advances to a step S44 if the decision result in the step S43 is YES, and the process advances to the step S45 if the decision result in the step S43 is NO.

In the step S44, the contents storage service SB decides whether or not to extend the term of validity of the print ticket by an extension time which is requested by the portal site 2 and included in the extension request to extend the term of validity of the print ticket received in the step S40. The process advances to a step S46 if the decision result in the step S44 is YES, and the process advances to a step S47 if the term of validity of the print ticket is to be extended by an extension time which is preset and the decision result in the step S44 is NO. For example, the contents storage service SB decides whether to extend the term of validity by the requested extension time or by the preset extension time, by referring to a flag or the like which is defined in the definition file stored in the HDD 19 or the like.

In the step S45, the contents storage service SB creates an extension response (or message) including information which indicates that the extension request was unsuccessful. In the step S46, the contents storage service SB extends the term of validity of the print ticket corresponding to the print ticket ID by the requested extension time. In the step S47, the contents storage service SB extends the term of validity of the print ticket corresponding to the print ticket ID by the preset extension time. The process advances to a step S48 after the step S46 or S47.

In the step S48, the contents storage service SB creates a new print ticket including the new term of validity (updated term of validity) which has been extended (updated) in the step S46 or S48, and the print ticket ID of the print ticket. In a step S49 which is carried out after the step 48, the contents storage service SB registers the newly created print ticket in the ticket storage section 40. In a step S50, the contents storage service SB deletes from the ticket storage section 40 the old print ticket corresponding to the print ticket ID which is included in the extension request to extend the term of validity of the print ticket received in the step S40.

In a step S51 after the step S50, the contents storage service SB creates an extension response including information which indicates that the extension request was successful, the new print ticket ID and the extended term of validity (updated term of validity). In a step S52, the contents storage service SB sends the extension response which is created by the step S45 or S51 to the portal site 2 which is the source of the extension request.

By carrying out the processes shown in FIG. 10, the service can extend the term of validity of the old ticket by making the old ticket no longer usable and creating a new ticket having the extended term of validity, in response to the extension request from the client which has the authority to extend the term of validity of the concerned ticket.

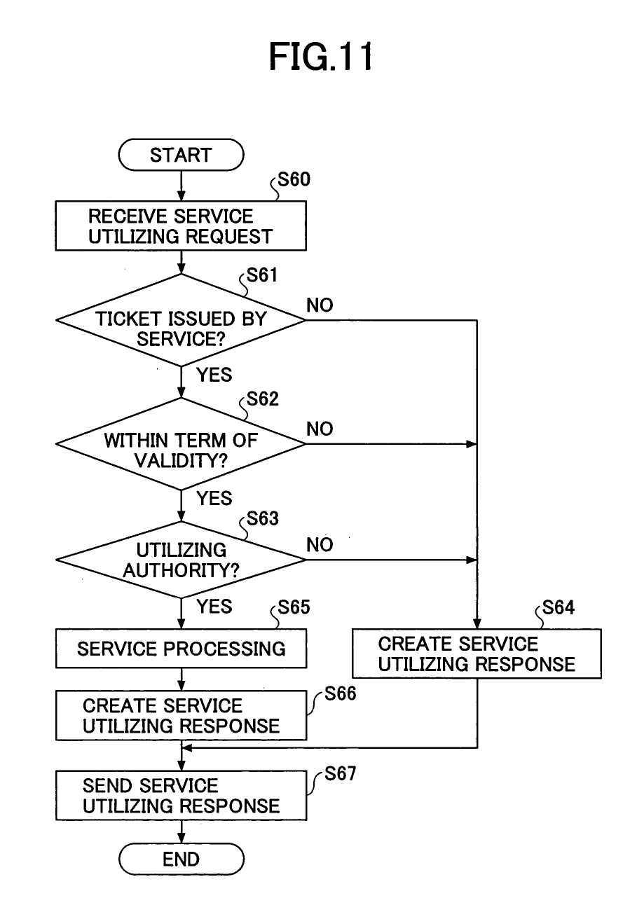

Next, a description will be given of a service providing process of this second embodiment, by referring to FIG. 11. FIG. 11 is a flow chart for explaining the service providing process of this second embodiment. In the following description of FIG. 11, it is assumed for the sake of convenience that the service producing process is carried out by the contents storage service SB, that is, the processes shown in FIG. 11 are carried out by the contents storage service SB.

In a step S60 shown in FIG. 11, the contents storage service SB receives a service utilizing request for the contents storage service SB from the print and distribution service SD. In a step S61, the contents storage service SB decides whether or not the a print ticket has been issued from the contents storage service SB by referring to the data in the ticket storage section 40 shown in FIG. 9, based on a print ticket ID and a client ID identifying the print and distribution service SD which are included in the service utilizing request received in the step S60. The process advances to a step S62 if the decision result in the step S61 is YES, and the process advances to a step S64 which will be described later if the decision result in the step S61 is NO.

In the step S62, the contents storage service SB decides whether or not the present time falls within a term of validity of the print ticket, by comparing the present time and the term of validity of the print ticket included in the print ticket corresponding to the print ticket ID. The process advances to a step S63 if the decision result in the step S62 is YES, and the process advances to the step S64 if the decision result in the step S62 is NO.

In the step S63, the contents storage service SB decides whether or not the print and distribution service SD has the authority to acquire the contents, for example, by referring to the client list shown in FIG. 4, based on the client ID for identifying the print and distribution service SD and a service utilizing type (for example, acquisition of the contents) which are included in the service utilizing request received in the step S60. The process advances to a step S65 if the decision result in the step S63 is YES, and the process advances to the step S64 if the decision result in the step S63 is NO.

In the step S64, the contents storage service SB creates a service utilizing response including information which indicates that the service utilizing request was unsuccessful. In the step S65, the contents storage service SB carries out the processes for providing the service requested by the print and distribution service SD, such as the process of acquiring the corresponding contents from the contents which are stored and managed by the contents storage service SB.

In a step S66 after the step S65, the contents storage service SB creates a service utilizing response including information which indicates that the service utilizing request was successful and the contents acquired in the step S65, for example. After the step S64 or S66, the process advances to a step S67. In the step S67, the contents storage service SB sends the service utilizing response created in the step S64 or S66 to the print and distribution service SD which is the source of the service utilizing request received in the step S60.

By carrying out the processes shown in FIG. 11, the service can provide the requested service depending on the service utilizing request from the client which has the service utilizing authority.

[Third Embodiment]

According to the first and second embodiments described above, the term of validity of the ticket may be set to an indefinitely long term. For this reason, the ticket having the indefinitely long term of validity may be abused by an unauthorized person if stolen, to deteriorate the security.

Hence, in this third embodiment, a length of the term of validity is limited when issuing a ticket or extending the term of validity of the ticket, so as to improve the security.

A functional structure of the service forming the pay-contents marketing service in this third embodiment includes a service providing section 70, a Web service interface (I/F) 10, a request processor 20, a ticket creating section 30, a ticket storage section 40, a ticket updating section 50, and a ticket inspecting section 60, similarly to the functional structure shown in FIG. 3. Hence, a description will only be given with respect to parts of this third embodiment which differ from those of the first and second embodiments described above, because the functions of this third embodiment are based on those of the first or second embodiment.

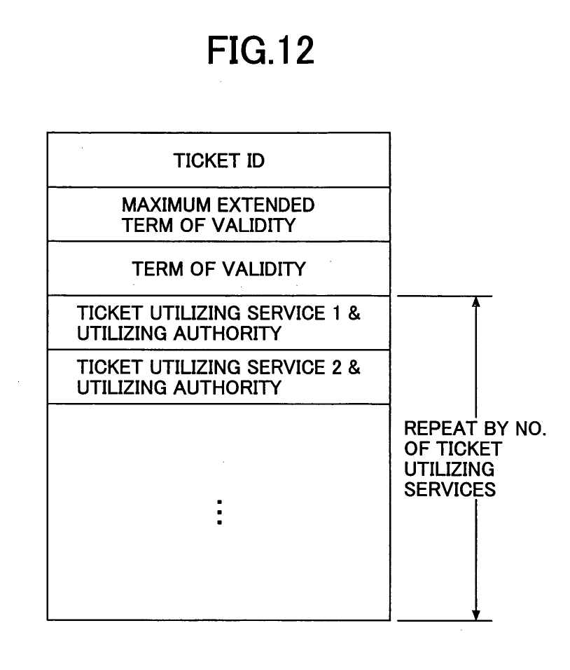

The ticket creating section 30 creates a ticket, similarly to the first and second embodiments described above, and stores the created ticket in the ticket storage section 40. The ticket which is created includes a ticket ID for identifying the ticket, a maximum extended term of validity, a term of validity, and a list of ticket utilizing services and utilizing authorities of the ticket utilizing services, as shown in FIG. 12. FIG. 12 is a diagram showing a data structure of the ticket in this third embodiment.

For example, the maximum extended term of validity may be calculated by the ticket creating section 30 or the like, by adding a ticket creating time (time and date of ticket creation) to a maximum value of an extension time which is preset in the definition file or the like which is stored in the HDD 19 or the like by the person in charge of managing the service which issues the ticket. The maximum value of the extension time which is preset may be determined depending on the level of security required by the service.

The ticket updating section 50 extends the term of validity of the ticket, similarly to the first or second embodiment described above. If the extended term of validity, which is extended by the extension time specified by the client or extended by the preset extension time, is greater than the maximum extended term of validity, the ticket is updated by setting the new term of validity to the maximum extended term of validity. For example, the extension time which is preset is determined depending on the level of security of the service, and may be set in the definition file stored in the HDD 19 or the like, by the person in charge of managing the service which issues the ticket.

By forming the services in the above described manner, it is possible to avoid the existence of indefinitely valid tickets. As a result, even if a ticket is stolen and the term of validity is extended by an unauthorized person, it is possible to prevent the unauthorized person from indefinitely using the stolen ticket.

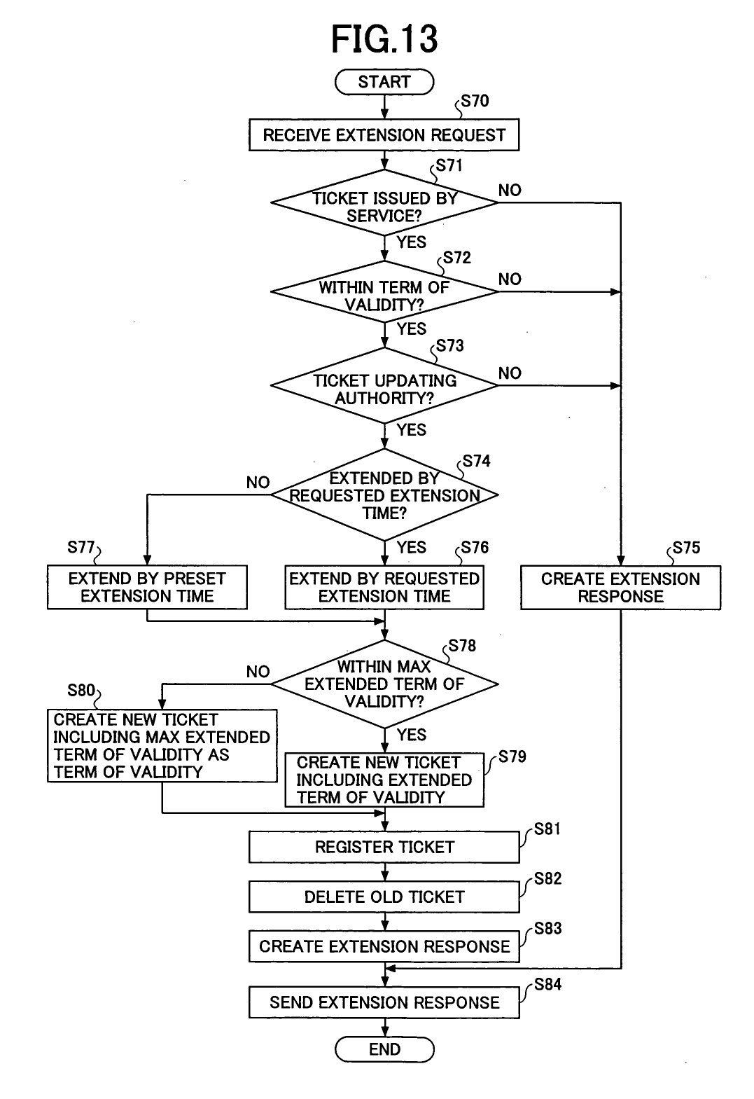

Next, a description will be given of a process of extending the term of validity of the ticket in this third embodiment, by referring to FIG. 13. FIG. 13 is a flow chart for explaining the process of extending the term of validity of the ticket in this third embodiment. In the following description of FIG. 13, it is assumed for the sake of convenience that the term of validity of the ticket is extended by the contents storage service SB, that is, the processes shown in FIG. 13 are carried out by the contents storage service SB. Moreover, it is assumed for the sake of convenience that this third embodiment employs the method of the second embodiment described above which deletes the old ticket and creates a new ticket.

In a step S70 shown in FIG. 13, the contents storage service SB receives an extension request to extend the term of validity of a print ticket from the portal site 2, for example. In a step S71, the contents storage service SB decides whether or not the print ticket has been issued by the contents storage service SB, by referring to the data stored in the ticket storage section 40 as shown in FIG. 9, based on a print ticket ID and a client ID identifying the portal site 2 which are included in the extension request received in the step S70. The process advances to a step S72 if the decision result in the step S71 is YES, and the process advances to a step S75 which will be described later if the decision result in the step S71 is NO.

In the step S72, the contents storage service SB decides whether or not the present time falls within the term of validity of the print ticket, by comparing the present time and the term of validity of the print ticket included in the print ticket corresponding to the print ticket ID. The process advances to a step S73 if the decision result in the step S72 is YES, and the process advances to the step S75 if the decision result in the step S72 is NO.

In the step S73, the contents storage service SB decides whether or not the portal site 2 which is the source of the extension request has the authority to update the print ticket, by referring to the client list shown in FIG. 4. The process advances to a step S74 if the decision result in the step S73 is YES, and the process advances to the step S75 if the decision result in the step S73 is NO.

In the step S74, the contents storage service, SB decides whether or not to extend the term of validity of the print ticket by an extension time which is requested by the portal site 2 and included in the extension request to extend the term of validity of the print ticket received in the step S70. The process advances to a step S76 if the decision result in the step S74 is YES, and the process advances to a step S77 if the term of validity of the print ticket is to be extended by an extension time which is preset and the decision result in the step S74 is NO. For example, the contents storage service SB decides whether to extend the term of validity by the requested extension time or by the preset extension time, by referring to a flag or the like which is defined in the definition file stored in the HDD 19 or the like.

In the step S75, the contents storage service SB creates an extension response (or message) including information which indicates that the extension request was unsuccessful. In the step S76, the contents storage service SB extends the term of validity of the print ticket corresponding to the print ticket ID by the requested extension time. In the step S77, the contents storage service SB extends the term of validity of the print ticket corresponding to the print ticket ID by the preset extension time. The process advances to a step S78 after the step S76 or S77.

In the step S78, the contents storage service SB decides whether or not the extended (updated) term of validity of the print ticket falls within the maximum extended term of validity, by comparing the extended (updated) term of validity extended in the step S76 or S77 and the maximum extended term of validity included in the print ticket as shown in FIG. 12, for example. The process advances to a step S79 if the decision result in the step S78 is YES, and the process advances to a step S80 if the decision result in the step S78 is NO.

In the step S79, the contents storage service SB creates a new print ticket which includes the extended (updated) term of validity and the newly assigned print ticket ID. On the other hand, in the step S80, the contents storage service SB creates a new print ticket which includes as the term of validity the maximum extended term of validity of the print ticket corresponding to the print ticket ID included in the extension request which is received in the step S70. This new ticket created in the step S80 also includes a newly assigned print ticket ID, similarly to the new print ticket created in the step S79. The process advances to a step S81 after the step S79 or S80.

In a step S81, the contents storage service SB registers the new print ticket which is newly created in the step S79 or S80 in the ticket storage section 40. In a step S82, the contents storage service SB deletes from the ticket storage section 40 the old print ticket corresponding to the print ticket ID which is included in the extension request to extend the term of validity of the print ticket received in the step S70.

In a step S83 after the step S82, the contents storage service SB creates an extension response including information which indicates that the extension request was successful, the new print ticket ID and the term of validity included in the new print ticket. In a step S84, the contents storage service SB sends the extension response which is created by the step S75 or S83 to the portal site 2 which is the source of the extension request.

By carrying out the processes shown in FIG. 13, the service can extend the term of validity of the old ticket by creating a new ticket having the extended term of validity which is extended within the preset maximum extended term of validity, in response to the extension request from the client which has the authority to extend the term of validity of the concerned ticket.

[Fourth Embodiment]

In the first, second and third embodiments described above, the term of validity of the ticket may be extended repeatedly by an unauthorized person if stolen. If the unauthorized person repeatedly extends the term of validity before each term expires, the ticket may be abused indefinitely by the unauthorized person, to deteriorate the security.

Hence, in this fourth embodiment, a maximum value is set with respect to a number of times the term of validity of the ticket may be extended, when issuing the ticket or when extending the term of validity, so as to improve the security.

A functional structure of the service forming the pay-contents marketing service in this fourth embodiment includes a service providing section 70, a Web service interface (I/F) 10, a request processor 20, a ticket creating section 30, a ticket storage section 40, a ticket updating section 50, and a ticket inspecting section 60, similarly to the functional structure shown in FIG. 3. Hence, a description will only be given with respect to parts of this fourth embodiment which differ from those of the first, second and third embodiments described above, because the functions of this fourth embodiment are based on those of the first, second or third embodiment.

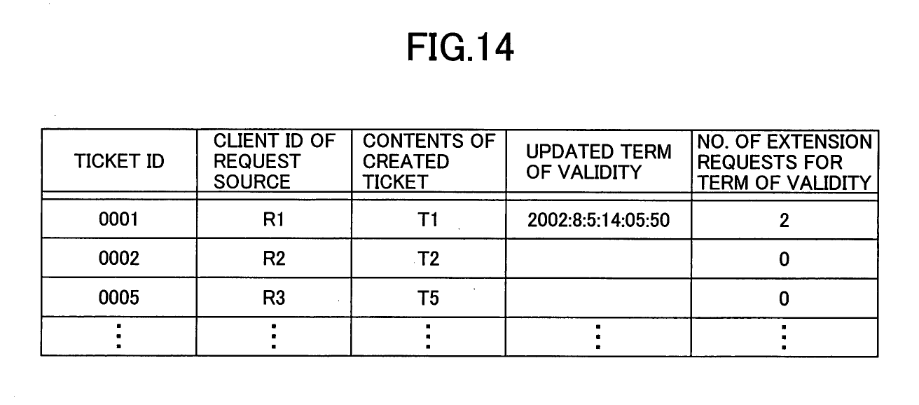

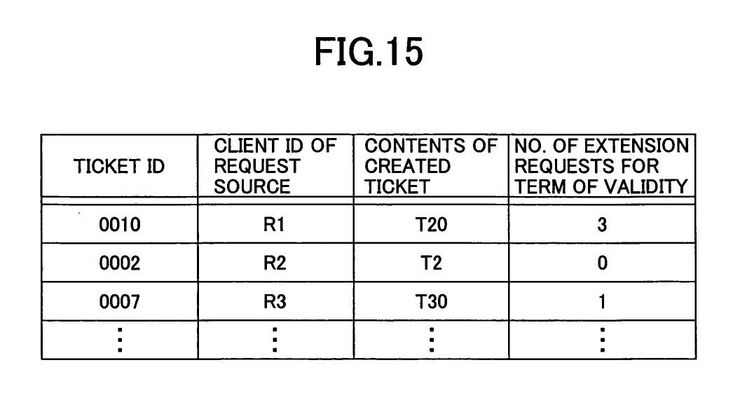

The ticket creating section 30 creates a ticket, similarly to the first, second and third embodiments described above, and stores the created ticket in the ticket storage section 40. In addition, the ticket creating section 30 sets a number of extension requests with respect to the stored ticket to zero, as shown in FIGS. 14 or 15.

FIG. 14 is a diagram showing a data structure of the ticket storage section 40 in this fourth embodiment when applied to the first embodiment. The data shown in FIG. 14 include the ticket ID, the client ID of the request source, the contents of the created ticket, the extended (updated) term of validity, and the number of extension requests.

FIG. 15 is a diagram showing a data structure of the ticket storage section 40 in this fourth embodiment when applied to the second embodiment. The data shown in FIG. 15 includes the ticket ID, the client ID of the request source, the contents of the created ticket, and the number of extension requests.

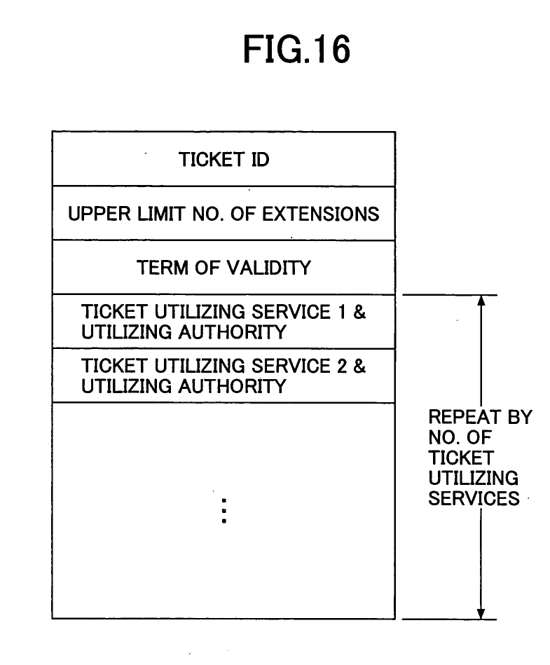

The ticket created by the ticket creating section 30 includes the ticket ID for identifying the ticket, an upper limit number of extensions, the term of validity, and the list of ticket utilizing services and the utilizing authorities of the ticket utilizing services, as shown in FIG. 16. FIG. 16 is a diagram showing a data structure of the ticket of the fourth embodiment.

The upper limit number of extensions is the maximum value of the number of times the term of validity of the ticket may be extended. For example, particularly in the case of an important ticket such as an authentication ticket for the Single-Sign-On, the upper limit value of extensions may be set to a small value. The upper limit number of extensions which is preset may be set in the definition file stored in the HDD 19 or the like, by the person in charge of managing the service which issues the ticket.

The ticket updating section 50 extends the term of validity of the ticket, similarly to the first, second or third embodiment described above, when the extension request is received. If the upper limit number of extensions is exceeded when extending the term of validity of the ticket, the ticket updating section 50 returns to the client an error message indicating that the extension request was unsuccessful. On the other hand, when the term of validity is extended (updated), the ticket updating section 50 counts up by one the number of extension requests for the ticket held in the ticket storage section 40.

When the service utilizing request is received, the ticket inspecting section 60 checks the ticket storage section 40 based on the ticket ID and the client ID which are received from the client, so as to determine whether the ticket has been issued by the service of interest. If the ticket has not been issued by the service of interest, the ticket inspecting section 60 returns to the client an error message indicating that the service utilizing request was unsuccessful.

On the other hand, if the ticket has been issued by the service of interest, the ticket inspecting section 60 compares the present time and the term of validity of the ticket included in the ticket which corresponds to the received ticket ID. If the present time does not fall within the term of validity, the ticket inspecting section 60 returns to the client an error message indicating that the service utilizing request was unsuccessful.

If the present time falls within the term of validity, the ticket inspecting section 60 acquires the service utilizing authority for the service which is requested by the service utilizing request from the client, and returns the service utilizing authority to the service providing section 70. The service providing section 70 carries out the processes of the requested service depending on the service utilizing authority.

By forming the services in the above described manner, it is possible to avoid the existence of indefinitely valid tickets because the number of extensions of the term of validity is limited by the ticket issuer. As a result, even if a ticket is stolen and the term of validity is extended by an unauthorized person, it is possible to prevent the unauthorized person from indefinitely using the stolen ticket.

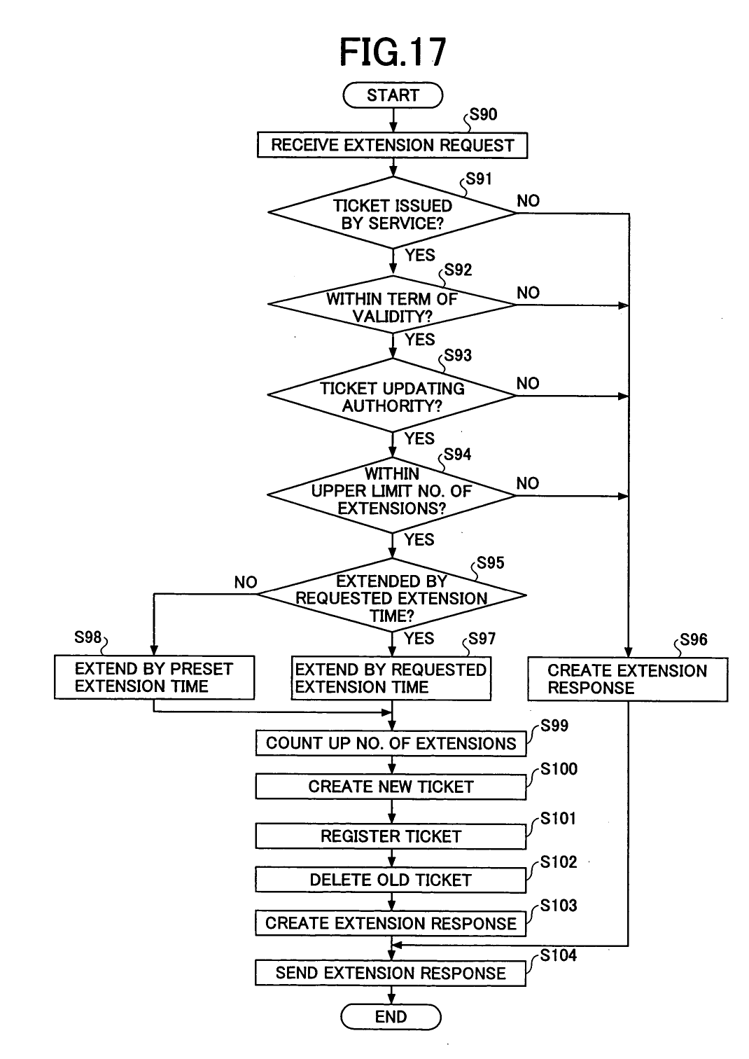

Next, a description will be given of a process of extending the term of validity of the ticket in this fourth embodiment, by referring to FIG. 17. FIG. 17 is a flow chart for explaining the process of extending the term of validity of the ticket in this fourth embodiment. In the following description of FIG. 17, it is assumed for the sake of convenience that the term of validity of the ticket is extended by the contents storage service SB, that is, the processes shown in FIG. 17 are carried out by the contents storage service SB. Moreover, it is assumed for the sake of convenience that this fourth embodiment employs the method of the second embodiment described above which deletes the old ticket and creates a new ticket.

In a step S90 shown in FIG. 17, the contents storage service SB receives an extension request to extend the term of validity of a print ticket from the portal site 2, for example. In a step S91, the contents storage service SB decides whether or not the print ticket has been issued by the contents storage service SB, by referring to the data stored in the ticket storage section 40 as shown in FIG. 9, based on a print ticket ID and a client ID identifying the portal site 2 which are included in the extension request received in the step S90. The process advances to a step S92 if the decision result in the step S91 is YES, and the process advances to a step S96 which will be described later if the decision result in the step S91 is NO.

In the step S92, the contents storage service SB decides whether or not the present time falls within the term of validity of the print ticket, by comparing the present time and the term of validity of the print ticket included in the print ticket corresponding to the print ticket ID. The process advances to a step S93 if the decision result in the step S92 is YES, and the process advances to the step S96 if the decision result in the step S92 is NO.

In the step S93, the contents storage service SB decides whether or not the portal site 2 which is the source of the extension request has the authority to update the print ticket, by referring to the client list shown in FIG. 4. The process advances to a step S94 if the decision result in the step S93 is YES, and the process advances to the step S96 if the decision result in the step S93 is NO.

In the step S94, the contents storage service SB decides whether or not the number of extension requests is within the upper limit number of extensions, by comparing the upper limit number of extensions of the ticket shown in FIG. 16 and the number of extension requests of the data in the ticket storage section 40 shown in FIG. 15, based on the print ticket ID included in the extension request to extend the term of validity of the print ticket received in the step S90. The process advances to a step S95 if the decision result in the step S94 is YES, and the process advances to the step S96 if the decision result in the step S94 is NO.

In the step S95, the contents storage service SB decides whether or not to extend the term of validity of the print ticket by an extension time which is requested by the portal site 2 and included in the extension request to extend the term of validity of the print ticket received in the step S90. The process advances to a step S97 if the decision result in the step S95 is YES, and the process advances to a step S98 if the term of validity of the print ticket is to be extended by an extension time which is preset and the decision result in the step S95 is NO. For example, the contents storage service SB decides whether to extend the term of validity by the requested extension time or by the preset extension time, by referring to a flag or the like which is defined in the definition file stored in the HDD 19 or the like.

In the step S96, the contents storage service SB creates an extension response (or message) including information which indicates that the extension request was unsuccessful. In the step S97, the contents storage service SB extends the term of validity of the print ticket corresponding to the print ticket ID by the requested extension time. In the step S98, the contents storage service SB extends the term of validity of the print ticket corresponding to the print ticket ID by the preset extension time. The process advances to a step S99 after the step S97 or S98.

In the step S99, the contents storage service SB counts up by one the number of extension requests of the data in the ticket storage section 40 shown in FIG. 15. In the step S100, the contents storage service SB creates a new print ticket which includes the extended (updated) term of validity which has been extended (updated) in the step S97 or S98 and the newly assigned print ticket ID. The process advances to a step S101 after the step S100.

In the step S101, the contents storage service SB registers the new print ticket which is newly created in the step S100 in the ticket storage section 40. In a step S102, the contents storage service SB deletes from the ticket storage section 40 the old print ticket corresponding to the print ticket ID which is included in the extension request to extend the term of validity of the print ticket received in the step S90.

In a step S103 after the step S102, the contents storage service SB creates an extension response including information which indicates that the extension request was successful, the new print ticket ID and the term of validity included in the new print ticket. In a step S104, the contents storage service SB sends the extension response which is created by the step S96 or S103 to the portal site 2 which is the source of the extension request.

By carrying out the processes shown in FIG. 17, the service can extend the term of validity of the old ticket by creating a new ticket having the extended term of validity which is extended within the upper limit number of extensions which is preset, in response to the extension request from the client which has the authority to extend the term of validity of the concerned ticket.

[Modification Of Fourth Embodiment]

In the fourth embodiment described above, the upper limit number of extensions is provided with respect to the extension request to extend the term of validity of the print ticket. But instead, it is of course possible to provide an upper limit number of times the ticket may be used, as in the case of a modification of the fourth embodiment described hereunder.

In this case, the ticket creating section 30, the ticket storage section 40, the ticket updating section 50 and the ticket inspecting section 60 have the following additional functions.

When the ticket creating request is received, the ticket creating section 30 creates a ticket, similarly to the fourth embodiment described above, and the created ticket is stored in the ticket storage section 40. In addition, the ticket creating section 30 sets a number of times the stored ticket is used to zero.

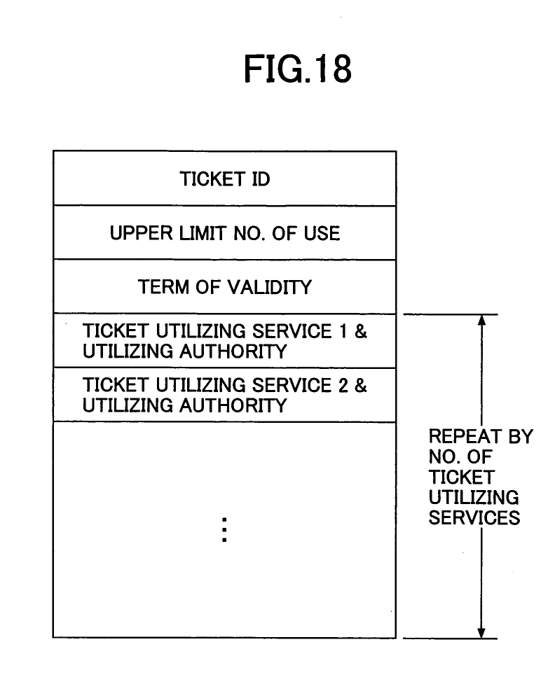

The ticket created by the ticket creating section 30 includes a ticket ID identifying the ticket, an upper limit number of times the ticket may be used, a term of validity, and a list of ticket utilizing services and utilizing authorities of the ticket utilizing services, as shown in FIG. 18. FIG. 18 is a diagram showing a data structure of the ticket in this modification of the fourth embodiment.

The upper limit number of times the ticket may be used, is the maximum value of the number of times the ticket may be used, which is preset. The maximum value of the number of times the ticket may be used, is determined depending on the level of security required for the service. For example, the maximum value which is preset may be set in the definition file stored in the HDD 19 or the like, by the person in charge of managing the service which issues the ticket.

When the extension request to extend the term of validity of the ticket is received, the ticket updating section 50 extends (updates) the term of validity of the ticket, similarly to the fourth embodiment described above. If the upper limit number of times the ticket may be used is exceeded when extending the term of validity of the ticket, the ticket updating section 50 returns to the client an error message indicating that the extension request was unsuccessful. On the other hand, when the term of validity of the ticket is extended (updated), the ticket updating section 50 counts up by one the number of times the ticket stored in the ticket storage section 40 is used.

When the service utilizing request is received, the ticket inspecting section 60 checks the ticket storage section 40 based on the ticket ID and the client ID which are received from the client, so as to determine whether or not the ticket has been issued by the service of interest, similarly to the fourth embodiment described above. If the ticket has not been issued by the service of interest, the ticket inspecting section 60 returns to the client an error message indicating that the service utilizing request was unsuccessful.

On the other hand, if the ticket has been issued by the service of interest, the ticket inspecting section 60 compares the number of times the ticket is used and the upper limit number of times the ticket may be used, which are included in the ticket corresponding to the received ticket ID. If the number of times the ticket is used exceeds the upper limit number of times the ticket may be used as a result of this comparison, the ticket inspecting section 60 returns to the client an error message indicating that the service utilizing request was unsuccessful.

In addition, if the ticket has been issued by the service of interest, the ticket inspecting section 60 compares the number of times the ticket is used and the upper limit number of times the ticket may be used, which are included in the ticket corresponding to the received ticket ID. If the number of times the ticket is used exceeds the upper limit number of times the ticket may be used as a result of this comparison, the ticket inspecting section 60 issues to the client an error message indicating that the service utilizing request was unsuccessful.

If the present times falls within the term of validity of the ticket, the ticket inspecting section 60 acquires the service utilizing authority for the service which is requested by the service utilizing request from the client, and returns the service utilizing authority to the service providing section 70. The service providing section 70 carries out the processes of the requested service depending on the service utilizing authority.

When the ticket inspecting section 60 carries out the processes of the requested service, the ticket inspecting section 60 counts up by one the number of times the ticket stored in the ticket storage section 40 is used.

In this modification of the fourth embodiment, the number of times the ticket is used is included in the process of extending (updating) the term of validity of the ticket. However, it is of course possible to count only the number of times the service is utilized as the number of times the ticket is used.

[Fifth Embodiment]

As described above with respect to the first embodiment described above, in the case of the pay-contents marketing service, the processes of the accounting service SC may take time after the contents storage service SB receives the print ticket for the contents the portal site 2, and the term of validity of the print ticket may expire before being supplied to the print and distribution service SD. If the term of validity of the print ticket expires during the processing of the requested service, it is necessary to acquire the print ticket again, and the portal site 2 must extend the term of validity of the print ticket.

Hence, in this fifth embodiment, the term of validity of the ticket is notified to a ticket creating request source if the term of validity of the ticket is about to expire, so that the notified ticket creating request source may make the extension request to extend the term of validity of the ticket in response to the notification and solve the problem of expiring ticket during the processing of the requested service.

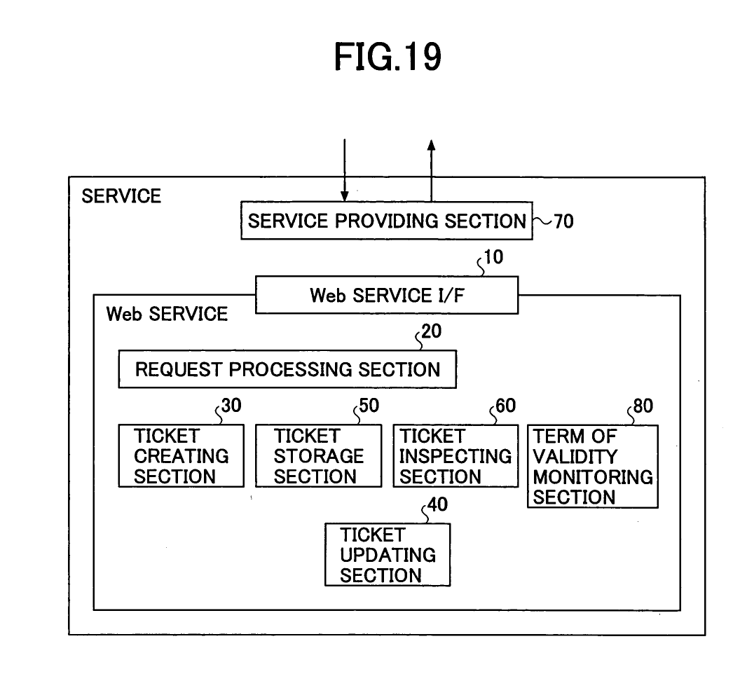

A functional structure of the service forming the pay-contents marketing service in this fifth embodiment includes a service providing section 70, a Web service interface (I/F) 10, a request processor 20, a ticket creating section 30, a ticket storage section 40, a ticket updating section 50, a ticket inspecting section 60, and a term of validity monitoring section, shown in FIG. 19. FIG. 19 is a diagram for explaining another functional structure of the service forming the pay-contents marketing service. A description will only be given with respect to parts of this fifth embodiment which differ from those of the first, second, third and fourth embodiments described above, because the functions of this fifth embodiment are based on those of the first, second, third or fourth embodiment.

The term of validity monitoring section 80 compares the present time and the term of validity of each ticket which is registered in the ticket storage section 40, for every first predetermined time (for example, every five minutes), so as to check whether or not the term of validity has become less than a second predetermined time (for example, three minutes).

If a ticket having a term of validity which is less than the second predetermined time is found, the term of validity monitoring section 80 acquires the client information of the client which made the ticket creating request, from the client list corresponding to the found ticket. In addition, the term of validity monitoring section 80 acquires the term of validity of this ticket which is found and is less than the second predetermined time. The term of validity monitoring section 80 notifies the acquired term of validity of the ticket to the client which made the ticket creating request based on the acquired client information.

For example, the following message may be sent from the term of validity monitoring section 80 to the client identified by the client information.

FROM2002-08-27T00:00:20ZTO202-08-27T00:04:20Z _XXXXXX

In this case, the message indicates that the ticket is valid from 00:00:20 Aug. 27, 2002 to 00:04:20 Aug. 27, 2002.

The following message may be sent from the term of validity monitoring section 80 to the client identified by the client information when the XML is used.

<Ticket>
<From>2002-08-27T00:00:20Z</From>
<To>2002-08-27T00:04:20Z</To>
<Challenge>XXXXXXX</Challenge>
</Ticket>

When the service which issued the ticket monitors the term of validity of this ticket and notifies the term of validity of this ticket as in this fifth embodiment, the service which uses this ticket can make an extension request to extend the term of validity of this ticket before the term of validity expires.

In addition, when the service which issued the ticket monitors the term of validity of this ticket and notifies the term of validity of this ticket as in this fifth embodiment, the service which made the ticket creating (issuing) request does not need to inquire the service which issued the ticket in order to know the term of validity of the ticket. In the case of the Web service, the overhead of the requests and the responses is large compared to the Component Object Model (COM), and it is important that no inquiry needs to be made in order to know the term of validity of the ticket.

Instead of making the extension request to extend the term of validity of the ticket at a timing in response to the notification from the service which issued the ticket as in the case of this fifth embodiment, it is of course possible to monitor the term of validity of the ticket by the client which made the ticket creating request. In this case, the client which made the ticket creating request may make the extension request when the term of validity of the ticket is about to expire. Furthermore, the client which made the ticket creating request may receive the ticket which is created or updated (extended) in response to this request and the term of validity after the creation or updating (extension) of the ticket, from the service which issued the ticket.

When monitoring the term of validity of the ticket in the term of validity monitoring section 80, if the term of validity of the ticket becomes less than the second predetermined time and is about to expire, the term of validity monitoring section 80 may notify the ticket updating section 50 if the client which made the ticket creating request has the authority to update the ticket. In this case, the ticket updating section 50 may automatically extend the term of validity of the ticket.

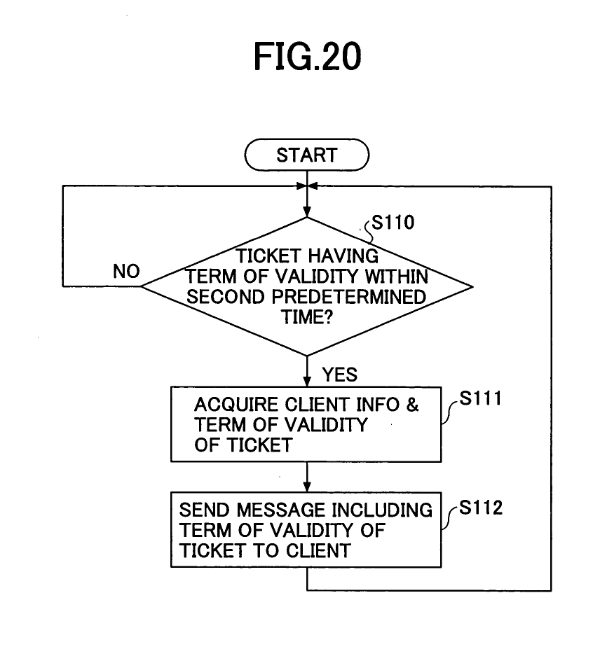

Next, a description will be given of a notification process related to extending the term of validity of the ticket in this fifth embodiment, by referring to FIG. 20. FIG. 20 is a flow chart for explaining the notification process related to extending the term of validity of the ticket in this fifth embodiment. In the following description of FIG. 20, it is assumed for the sake of convenience that the term of validity of the ticket is extended by the contents storage service SB, that is, the processes shown in FIG. 20 are carried out by the contents storage service SB.

In a step S110 shown in FIG. 20, the contents storage service SB compares the present time and the term of validity of each ticket registered in the ticket storage section 40 for every first predetermined time (for example, five minutes), so as to determine whether or not a ticket having a term of validity less than the second predetermined time (for example, three minutes) exists. The step S110 is repeated if the decision result in the step S110 is NO. On the other hand, if the decision result in the step S110 becomes YES, the process advances to a step S111. For example, the first and second predetermined times which are preset may be set in the definition file stored in the HDD 19 or the like, by the person in charge of managing the service which issues the ticket.

In the step S111, the contents storage service SB acquires the term of validity of the corresponding ticket and the client information from the ticket storage section 40, and the process advances to a step S112. In the step S112, the content storage service SB sends a message including the term of validity of the ticket acquired in the step S111 to the client included in the client information acquired in the step S111.

By carrying out the processes shown in FIG. 20, the service can send the information related to the extension of the term of validity of the ticket to the client which made the ticket creating request.

Of course, it is possible to extend the term of validity of the ticket while maintaining a high security by appropriating combining two or more embodiments described above.

[Sixth Embodiment]

In the first through fifth embodiments described above, the structures and processes were described mainly with respect to the user authentication service SA, the contents storage services SB and the like. In this sixth embodiment and a seventh embodiment which will be described later, a description will be given particularly with respect to the structure and processes of the portal site 2.

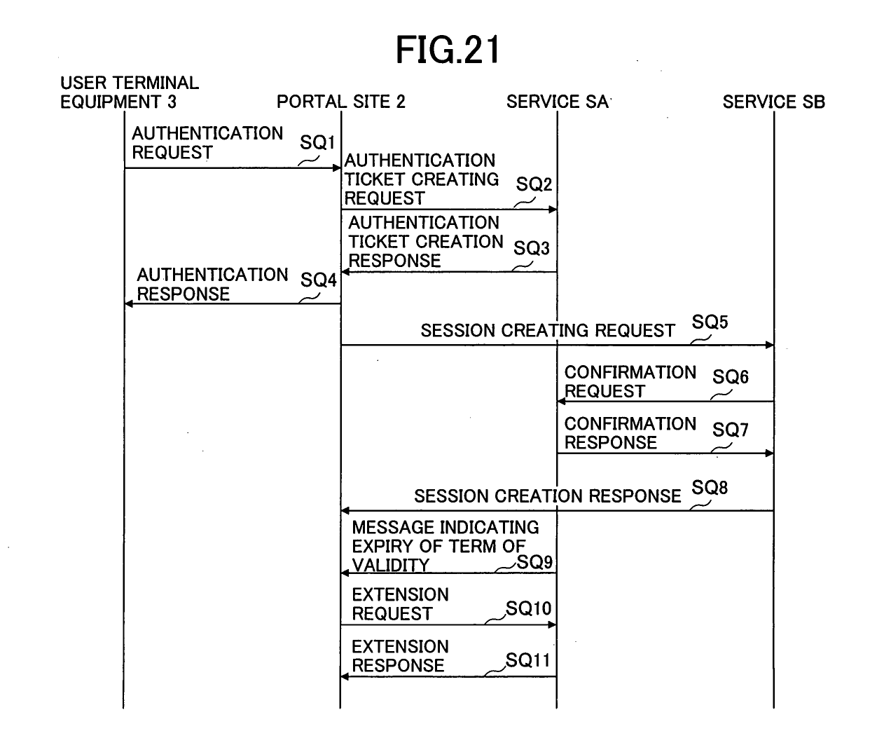

FIG. 21 is a sequence diagram for explaining this sixth embodiment.

In a sequence SQ1 shown in FIG. 21, the portal site 2 receives an authentication request including the user name and the password, for example, from the user terminal equipment 3, as described above with reference to FIG. 1.

When the authentication request including the user name and the password is received from the user terminal equipment 3, the portal site 2 temporarily stores the user name and the password, and creates an authentication ticket creating request including the user name and the password. In a sequence SQ2, the portal site 2 creates the authentication ticket creating request, including the term of validity of the ticket and the services utilized by the portal site 2 (for example, the services SB, SC and SD) in addition to the user name and the password, and sends the authentication ticket creating request to the user authentication service SA, as described above in conjunction with the first embodiment.

Since the portal site 2 stores the user name and the password, it is possible to send a new authentication ticket creating request with respect to the user authentication service SA using the user name and the password which are stored, even if the term of validity of the authentication ticket expires, for example.

In a sequence SQ3, the user authentication service SA makes a user authentication based on the user name and the password, for example, which are included in the authentication ticket creating request, when the authentication ticket creating request is received from the portal site 2. In addition, if the user authentication is successful, the user authentication service SA creates, stores and manages the authentication ticket having the term of validity, as described above in conjunction with the first through fifth embodiments. Furthermore, the user authentication service SA creates an authentication ticket creation response including an authentication ticket ID for identifying the authentication ticket, a term of validity included in the authentication ticket, and information indicating that the authentication was successful, and sends the authentication ticket creation response to the portal site 2 at the request source.

In a sequence SQ4, when the portal site 2 receives the authentication ticket creation response including the authentication ticket ID for identifying the authentication ticket, the term of validity included in the authentication ticket and the information indicating that the authentication was successful, from the user authentication service SA, the portal site 2 stores an manages the authentication ticket ID and the term of validity of the authentication ticket. In addition, the portal site 2 creates an authentication response including information indicating that the authentication was successful, and sends the authentication response to the user terminal equipment 3 at the request source.

In a sequence SQ5, the portal site 2 creates a session creating request which includes the authentication ticket ID stored and managed therein, so as to make a session with a service (for example, services SB, SC and SD) to be utilized by the portal site 2. Furthermore, the portal site 2 sends the session creating request to the service to be utilized by the portal site 2. In the particular case shown in FIG. 21, the portal site 2 sends the session creating request to the contents storage service SB.

In a sequence SQ6, the contents storage service SB creates an authentication ticket ID confirmation request, which includes the authentication ticket ID included in the session creating request, when the session creating request is received from the portal site 2. Moreover, the contents storage service SB sends the authentication ticket ID confirmation request to the user authentication service SA.

In a sequence SQ7, when the user authentication service SA receives the authentication ticket ID confirmation request, the user authentication service SA judges whether or not the authentication ticket ID is that for the valid authentication ticket created by the user authentication service SA. In addition, if it is judged that the authentication ticket ID is that for the valid authentication ticket created by the user authentication service SA, the user authentication service SA creates an authentication ticket ID confirmation response which includes information indicating that the authentication ticket ID is valid, and sends the authentication ticket ID confirmation response to the contents storage service SB at the request source.

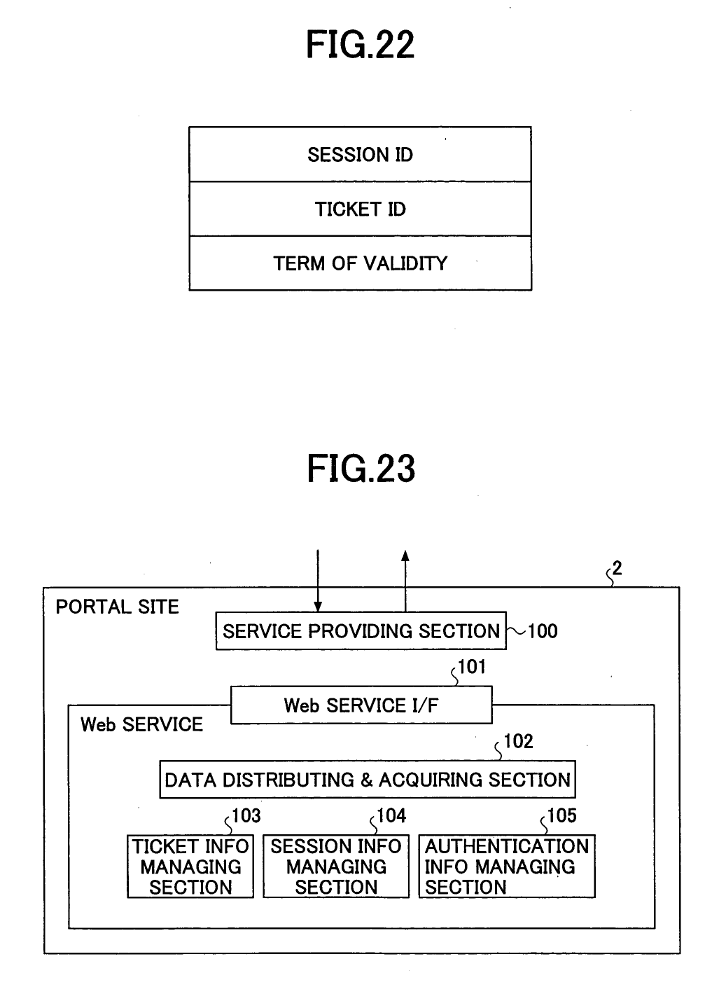

In a sequence SQ8, when the contents storage service SB receives the authentication ticket ID confirmation response which includes the information indicating that the authentication ticket ID is valid, the contents storage service SB creates a session shown in FIG. 22 including the authentication ticket ID, a session ID for identifying the session, and a term of validity of the session, for example. FIG. 22 is a diagram showing a data structure of the session. The contents storage service SB stores and manages the session. Furthermore, the contents storage service SB creates a session creation response including the session ID, and sends the session creation response to the portal site 2 at the request source.

In a sequence SQ9, the user authentication service SA monitors the term of validity of the authentication ticket which is created depending on the authentication ticket creating request of the sequence SQ2, for every first predetermined time (for example, five minutes) as described above in conjunction with the fifth embodiment, for example. If the term of validity of the authentication ticket becomes less than the second predetermined time (for example, three minutes), the user authentication service SA creates a notification message indicating that the term of validity of the authentication ticket has become less than the second predetermined time, that is, indicating that the term of validity of the authentication ticket is about to expire. The user authentication service SA sends the notification message to the portal site 2 which made the authentication ticket creating request.

In a sequence SQ10, when the notification message from the user authentication service SA indicating that the term of validity of the authentication ticket is about to expire, the portal site 2 judges whether or not to extend the term of validity of the authentication ticket. If the portal site 2 judges that the term of validity of the authentication ticket is to be extended, the portal site 2 creates an extension request to extend the term of validity, including the authentication ticket ID, a requested extension time, and an identifier identifying the portal site 2. The portal site 2 sends the extension request to the user authentication service SA.

In a sequence SQ11, when the extension request to extend the term of validity of the authentication ticket is received from the portal site 2, the user authentication service SA extends the term of validity according to the method of any of the first through fifth embodiments described above, and creates an extension response. This extension response includes the extended term of validity, and the authentication ticket ID identifying the authentication ticket for which the term of validity has been extended. The user authentication service SA sends the extension response to the portal site 2 at the request source.

Hence, the portal site 2 can make a session with a service other than the contents storage service SB, for example, using the authentication ticket ID identifying the authentication ticket for which the term of validity has been extended.

In FIG. 21, the processes of the sequences SQ9 through SQ11 may be carried out before the process of the sequence SQ5.

FIG. 23 is a diagram for explaining a functional structure of the service forming the portal site 2 in this sixth embodiment. A functional structure of the service forming the portal site 2 in this sixth embodiment includes a service providing section 100, a Web service interface (I/F) 101, a data distributing and acquiring section 102, a ticket information managing section 103, a session information managing section 104, and an authentication information managing section 105, as shown in FIG. 23.

The service providing section 100 receives a request from the user terminal equipment 3, and provides a corresponding service (for example, the user authentication service SA) to the user terminal equipment 3, and sends a service request to the services (for example, the services SA, SB, SC and SD) to receive results of processing from the corresponding services.

For example, the service providing section 100 sends an authentication ticket creating request to the user authentication service SA in response to an authentication request from the user terminal equipment 3, and receives an authentication ticket creation response from the user authentication service SA. The service providing section 100 also sends an authentication response indicating whether or not the authentication was successful, to the user terminal equipment 3 at the request source. In addition, the service providing section 100 sends a session creating request to the contents storage service SB, for example, and receives a session creation response from the contents storage service SB. The service providing section 100 also sends an extension request to extend the term of validity of the authentication ticket, to the user authentication service SA, and receives from the user authentication service SA an extension response indicating whether or not the extension of the term of validity was successful.

When the service providing section 100 carries out a function, the Web service I/F 101 intermediates with key functions of the Web service.

The data distributing and acquiring section 102 stores data in and acquires data from the ticket information managing section 103, the session information managing section 104 or the authentication information managing section 105, depending on a message which is exchanged by the service providing section 100.

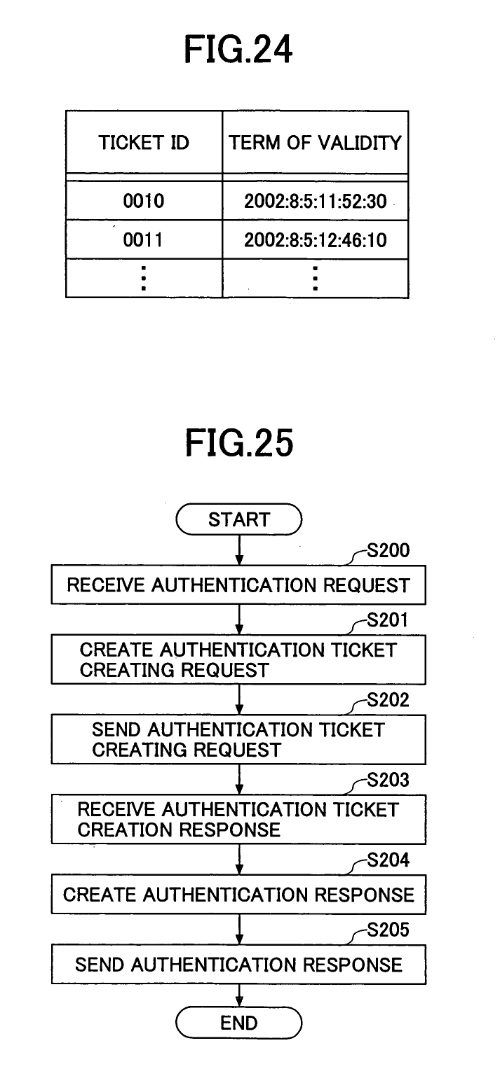

The ticket information managing section 103 manages information related to the authentication ticket, such as the authentication ticket ID and the term of validity of the authentication ticket, as shown in FIG. 24. FIG. 24 is a diagram showing a data structure in the ticket information managing section 103. Of course, the ticket information managing section 103 may further manage the print ticket ID, the term of validity of the print ticket, and the like as in the case of the first embodiment described above. In the following description, it is assumed for the sake of convenience that the ticket information managing section 103 manages the authentication ticket ID and the term of validity of the authentication ticket.

The session information managing section 105 manages information related to the session between the portal site 2 and the services, such as the session ID.

The authentication information managing section 105 manages information related to the authentication, such as the user name and the password.

Next, a description will be given of an authentication ticket creating request process of the portal site 2, by referring to FIG. 25. FIG. 25 is a flow chart for explaining the authentication ticket creating request process of the portal site 2.

In a step S200 shown in FIG. 25, the portal site 2 receives an authentication request, including the user name and the password, for example, from the user terminal equipment 3. In a step S201, the portal site 2 creates an authentication ticket creating request which includes the user name and the password included in the authentication request received in the step S200. As described above, the authentication ticket creating request includes the term of validity of the authentication ticket, and the identifier identifying the service (for example, the services SB, SC and SD) to be utilized by the portal site 2. In a step S202, the portal site 2 sends the authentication ticket creating request created in the step S201 to the corresponding user authentication service SA.

In a step S203, the portal site 2 receives from the user authentication service SA the authentication ticket ID identifying the authentication ticket, the term of validity included in the authentication ticket, and the information indicating that the authentication was successful. The portal site 2 stores and manages the authentication ticket ID for identifying the authentication ticket included in the received authentication ticket creation response, and the term of validity included in the authentication ticket. In a step S204, the portal site 2 creates an authentication response indicating that the authentication was successful, for example. In a step S205, the portal site 2 sends the authentication response which is created in the step S204 to the user terminal equipment 3 at the authentication request source.

By carrying out the processes shown in FIG. 25, the portal site 2 causes the user authentication service SA to carry out the authentication in response to the authentication request from the user terminal equipment 3, and sends a result of the authentication to the user terminal equipment 3 at the request source. In addition, the portal site 2 can make a session with a service to be utilized by the portal site 2 or, send an extension request to extend the term of validity of the authentication ticket to the user authentication service SA, using the acquired authentication ticket ID which identifies the authentication ticket which certifies the authentication.

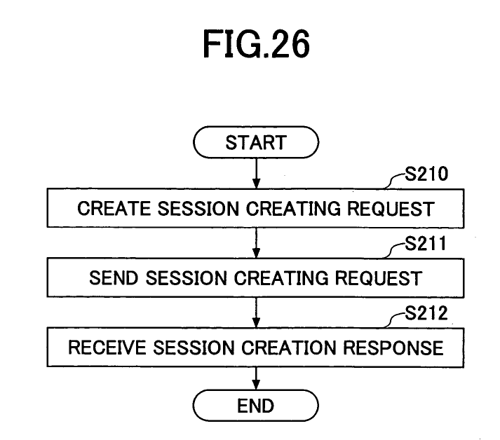

Next, a description will be given of a session creating request process of the portal site 2, by referring to FIG. 26. FIG. 26 is a flow chart for explaining the session creating request process of the portal site 2. In the following description, it is assumed for the sake of convenience that the portal site 2 makes a session with the contents storage service SB.

In a step S210 shown in FIG. 26, the portal site 2 creates a session creating request including an authentication ticket ID. In a step S211, the portal site 2 sends the session creating request which is created in the step S210 to the contents storage service SB. In a step S212, the portal site 2 receives from the contents storage service SB a session creation response including a session ID for identifying the session. The portal site 2 stores and manages the session ID included in the session creation response which is received, and uses the session ID when utilizing the service provided by the contents storage service SB.

By carrying out the processes shown in FIG. 26, the portal site 2 can make a session with the service (for example, services SB, SC and SD) to be utilized by the portal site 2, using the authentication ticket ID.

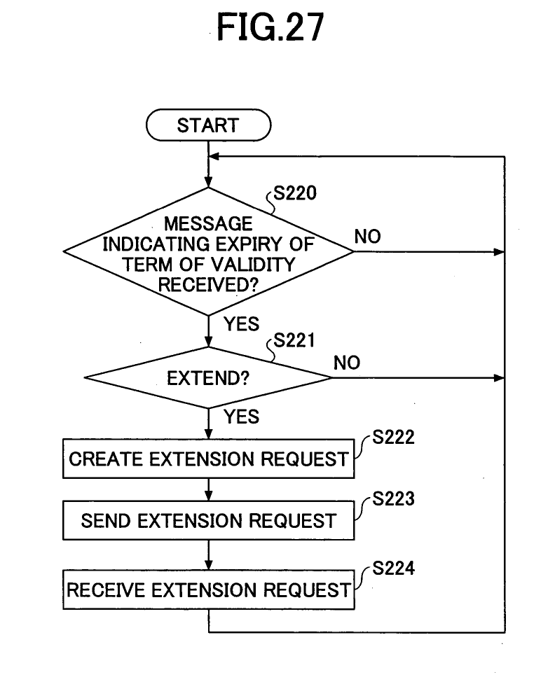

Next, a description will be given of an extension request process of the portal site 2 with respect to the extension request to extend the term of validity of the authentication ticket, by referring to FIG. 27. FIG. 27 is a flow chart for explaining the extension request process of the portal site 2.

In a step S220 shown in FIG. 27, the portal site 2 decides whether or not a notification message indicating that the term of validity of the authentication ticket has become less than a second predetermined time, that is, a notification message indicating that the term of validity of the authentication ticket is about to expire, is received from the user authentication service SA. The step S220 is repeated if the decision result in the step S220 is NO. The process advances to a step S221 if the decision result in the step S220 becomes YES.

In the step S221, the portal site 2 decides whether or not to extend the term of validity of the authentication ticket for which the notification message received in the step S220 indicates that the term of validity is about to expire. If the decision result in the step S221 is NO, the process returns to the step S220. On the other hand, the process advances to a step S222 if the decision result in the step S221 is YES.

For example, if the user makes a valid log-in to the portal site 2 from the user terminal equipment 3, the portal site 2 judges that the term of validity of the authentication ticket is to be extended. If the user makes an invalid log-in to the portal site 2 from the user terminal equipment 3, the portal site 2 judges that the term of validity of the authentication ticket is not to be extended.

In the step S222, the portal site 2 creates an extension request to extend the term of validity of the authentication ticket. This extension request includes the authentication ticket ID, the requested extension time, and the identifier for identifying the portal site 2. In a step S223, the portal site 2 sends the extension request created in the step S222 to the user authentication service SA. In a step S224, the portal site 2 receives from the user authentication service SA an extension response including the extended term of validity, and the authentication ticket ID for identifying the authentication ticket having the extended term of validity.

By carrying out the processes shown in FIG. 27, the portal site 2 can make the extension request to request extension of the term of validity of the authentication ticket.

[Seventh Embodiment]

In the sixth embodiment described above, the user authentication service SA monitors the term of validity of the authentication ticket, and makes a notification indicating that the term of validity is about to expire, with respect to the portal site 2. However, the portal site 2 may monitor the term of validity of the authentication ticket, and send an extension request to extend the term of validity of the authentication ticket when the term of validity is about to expire.

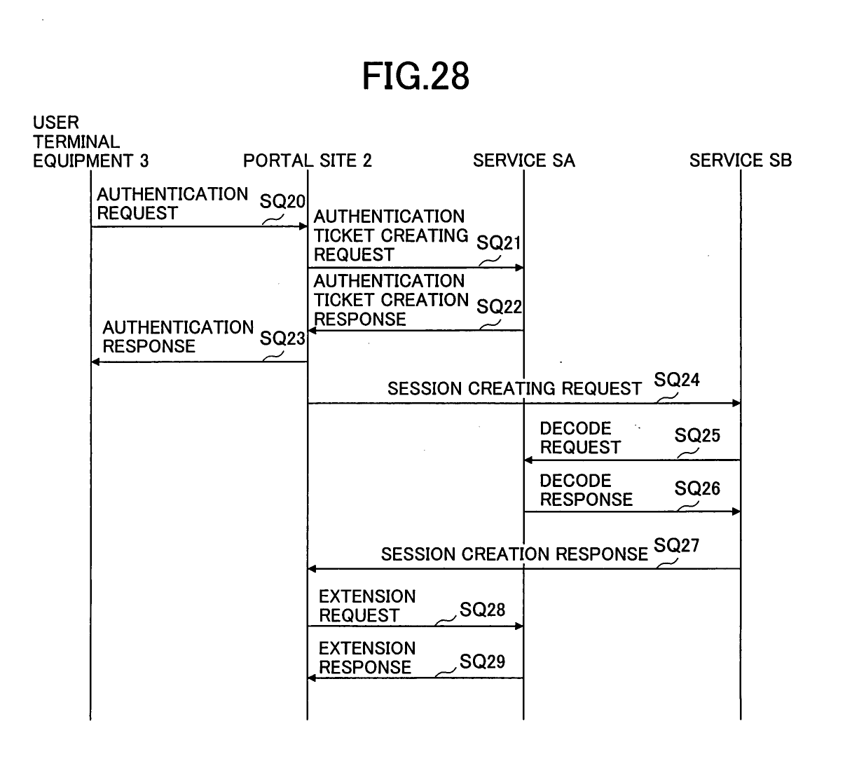

Hence, a description will now be given of a seventh embodiment in which the portal site 2 monitors the term of validity of the authentication ticket, by referring to FIG. 28. FIG. 28 is a sequence diagram for explaining the seventh embodiment. In FIG. 28, processes of sequences SQ20 through SQ27 are respectively the same as those of the sequences SQ1 through SQB shown in FIG. 21, and a description thereof will be omitted.

The portal site 2 monitors the authentication ticket ID and the term of validity of the authentication ticket corresponding to the authentication ticket ID which are stored and managed as shown in FIG. 24, for every first predetermined time (for example, five minutes). If the term of validity of the authentication ticket becomes less than a second predetermined time (for example, three minutes), the portal site 2 judges whether or not to extend the term of validity of the authentication ticket.

In a sequence SQ28 shown in FIG. 28, if the portal site 2 judges that the term of validity of the authentication ticket is to be extended, the portal site 2 creates and sends to the user authentication service SA an extension request including the authentication ticket ID, the requested extension time and the identifier identifying the portal site 2.

In a sequence SQ29, when the extension request is received from the portal site 2, the user authentication service SA extends the term of validity of the authentication ticket according to the method of any of the first through fifth embodiments described above, and creates an extension response. The extension response includes the extended term of validity, and the authentication ticket ID identifying the authentication ticket having the extended term of validity, and the user authentication service SA sends the extension response to the portal site 2 at the request source.

The portal site 2 can make a session with a service other than the contents storage service SB, for example, using the authentication ticket ID identifying the authentication ticket having the extended term of validity.

The processes of the sequences SQ28 and SQ29 may be carried out before the process of the sequence SQ24.

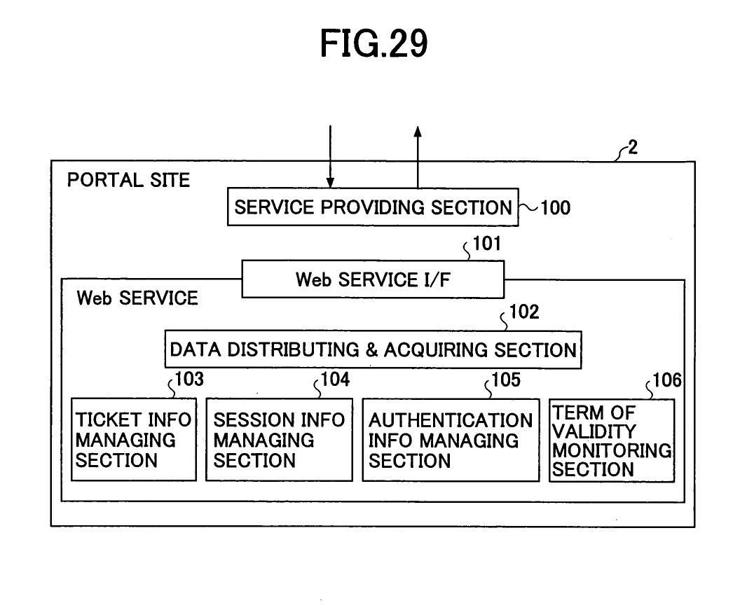

FIG. 29 is a diagram for explaining another functional structure of the service forming the portal site 2 in this seventh embodiment. A functional structure of the service forming the portal site 2 in this seventh embodiment includes a service providing section 100, a Web service interface (I/F) 101, a data distributing and acquiring section 102, a ticket information managing section 103, a session information managing section 104, an authentication information managing section 105, and a term of validity monitoring section 106, as shown in FIG. 29.

Since the functions of the service providing section, the Web service I/F 101, the data distributing and acquiring section 102, the ticket information managing section 103, the session information managing section 104 and the authentication information managing section 105 are the same as those of the sixth embodiment shown in FIG. 23, a description thereof will be omitted. Only the term of validity monitoring section 106 will be described in the following.

The term of validity monitoring section 106 compares the present time and the term of validity of the authentication ticket managed in the ticket information managing section 103, for every first predetermined time (for example, five minutes), and judges whether or not the term of validity is less than a second predetermined time (for example, three minutes). If the term of validity monitoring section 106 judges that the term of validity of the authentication ticket is less than the second predetermined time, the term of validity monitoring section 106 further judges whether or not to extend the term of validity. If it is judged that the term of validity of the authentication ticket is to be extended, the term of validity monitoring section 106 notifies the service providing section 100 via the Web I/F 101 and the like, that the term of validity of the authentication ticket is to be extended.

The service providing section 100 creates an extension request to extend the term of validity of the authentication ticket when the notification, indicating that the term of validity is to be extended, is received from the term of validity monitoring section 106. In addition, the service providing section 100 sends to the user authentication service SA an extension request to extend the term of validity of the authentication ticket.

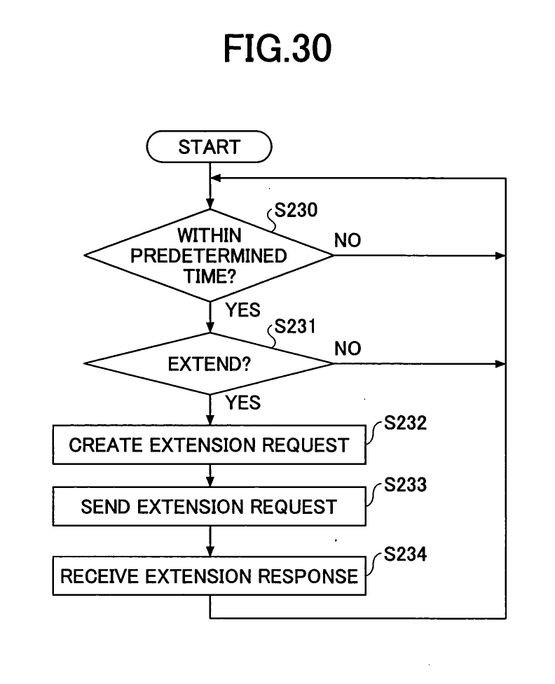

Next, a description will be given of an extension request process of the portal site 2, by referring to FIG. 30. FIG. 30 is a flow chart for explaining the extension request process of the portal site 2 in the seventh embodiment.

In a step S230 shown in FIG. 30, the portal site 2 compares the present time and the term of validity of the authentication ticket stored and managed by the ticket information managing section 103, for every first predetermined time (for example, five minutes), and decides whether or not the term of validity of the authentication ticket has become less than a second predetermined time (for example, three minutes). The step S230 is repeated if the decision result in the step S230 is NO. The process advances to a step S231 if the decision result in the step S230 becomes YES. For example, the first and second predetermined times which are preset may be set in the definition file stored in the HDD 19 or the like, by the person in charge of managing the portal site 2.

In the step S231, the portal site 2 decides whether or not to extend the term of validity of the authentication ticket which has become less than the second predetermined time in the step S230. If the decision result in the step S231 is NO, the process returns to the step S230. On the other hand, the process advances to a step S232 if the decision result in the step S231 is YES.

For example, if the user makes a valid log-in to the portal site 2 from the user terminal equipment 3, the portal site 2 judges that the term of validity of the authentication ticket is to be extended. If the user makes an invalid log-in to the portal site 2 from the user terminal equipment 3, the portal site 2 judges that the term of validity of the authentication ticket is not to be extended.

In the step S232, the portal site 2 creates an extension request to extend the term of validity of the authentication ticket. This extension request includes the authentication ticket ID, the requested extension time, and the identifier for identifying the portal site 2. In a step S233, the portal site 2 sends the extension request created in the step S232 to the user authentication service SA. In a step S234, the portal site 2 receives from the user authentication service SA an extension response including the extended term of validity, and the authentication ticket ID for identifying the authentication ticket having the extended term of validity.

By carrying out the processes shown in FIG. 30, the portal site 2 can monitor the term of validity of the authentication ticket, and send an extension request to request extension of the term of validity of the authentication ticket to a corresponding service when the portal site 2 judges that the term of validity is to be extended.

Further, the present invention is not limited to these embodiments, but various variations and modifications may be made without departing from the scope of the present invention.

What is claimed is:

1. A service providing apparatus comprising:
a service providing section to provide services, said service providing section comprising:
an authentication information managing section to manage authentication information related to the services and having a term of validity;
an extension request accepting section to accept an extension request to extend the term of validity of the authentication information; and
an authentication information updating section to extend the term of validity of the authentication information depending on the extension request.

2. The service providing apparatus as claimed in claim 1, wherein said authentication information managing section manages, in a related manner, the authentication information, information related to a request source which makes the extension request to extend the term of validity of the authentication information, and an authority to extend the term of validity of the authentication information.

3. The service providing apparatus as claimed in claim 1, wherein said authentication information managing section manages, in a related manner, the authentication information, information related to a request source which made a creating request to create the authentication information, information related to a request source which makes the extension request to extend the term of validity of the authentication information, and an authority to extend the term of validity of the authentication information.

4. The service providing apparatus as claimed in claim 1, wherein said authentication information updating section judges whether or not a request source which made the extension request to extend the term of validity of the authentication information has an authority to extend the term of validity, and extends the term of validity of the authentication information when it is judged that the request source has the authority to extend the term of validity.

5. The service providing apparatus as claimed in claim 1, wherein said authentication information updating section judges whether or not a request source which made the extension request to extend the term of validity of the authentication information has an authority to extend the term of validity, extends the term of validity of the authentication information when it is judged that the request source has the authority to extend the term of validity, and creates new authentication information including the extended term of validity.

6. The service providing apparatus as claimed in claim 1, wherein said authentication information managing section manages the authentication information and an extended term of validity of the authentication information in a related manner.

7. The service providing apparatus as claimed in claim 1, wherein said authentication information managing section manages the authentication information and a number of times the term of validity of the authentication information is extended in a related manner.

8. The service providing apparatus as claimed in claim 1, wherein said service providing section further comprises a extension response sending section to send an extension response including an identifier for identifying the authentication information having the term of validity extended by said authentication information updating section and the term of validity of the authentication information.

9. The service providing apparatus as claimed in claim 1, wherein said service providing section further comprises a monitoring section to monitor the term of validity of the authentication information.

10. The service providing apparatus as claimed in claim 1, wherein said service providing section further comprises a notifying section to notify information related to the term of validity of the authentication information to a request source which made a creating request to create the authentication information.

11. A service providing method to provide services, comprising:
an authentication information managing step to manage authentication information related to the services and having a term of validity;
an extension request accepting step to accept an extension request to extend the term of validity of the authentication information; and
an authentication information updating step to extend the term of validity of the authentication information depending on the extension request.

12. The service providing method as claimed in claim 11, wherein said authentication information managing step manages, in a related manner, the authentication information, information related to a request source which makes the extension request to extend the term of validity of the authentication information, and an authority to extend the term of validity of the authentication information.

13. The service providing method as claimed in claim 11, wherein said authentication information managing step manages, in a related manner, the authentication information, information related to a request source which made a creating request to create the authentication information, information related to a request source which makes the extension request to extend the term of validity of the authentication information, and an authority to extend the term of validity of the authentication information.

14. The service providing method as claimed in claim 11, wherein said authentication information updating step judges whether or not a request source which made the extension request to extend the term of validity of the authentication information has an authority to extend the term of validity, and extends the term of validity of the authentication information when it is judged that the request source has the authority to extend the term of validity.

15. The service providing method as claimed in claim 11, wherein said authentication information updating step judges whether or not a request source which made the extension request to extend the term of validity of the authentication information has an authority to extend the term of validity, extends the term of validity of the authentication information when it is judged that the request source has the authority to extend the term of validity, and creates new authentication information including the extended term of validity.

16. The service providing method as claimed in claim 11, wherein said authentication information managing step manages the authentication information and an extended term of validity of the authentication information in a related manner.

17. The service providing method as claimed in claim 11, wherein said authentication information managing step manages the authentication information and a number of times the term of validity of the authentication information is extended in a related manner.

18. The service providing method as claimed in claim 11, further comprising:
a extension response sending step to send an extension response including an identifier for identifying the authentication information having the term of validity extended by said authentication information updating step and the term of validity of the authentication information.

19. The service providing method as claimed in claim 11, further comprising:
a monitoring step to monitor the term of validity of the authentication information.

20. The service providing method as claimed in claim 1, further comprising:
a notifying step to notify information related to the term of validity of the authentication information to a request source which made a creating request to create the authentication information.

21. A computer-readable storage medium which stores a program for causing a computer to provide services, said program comprising:
an authentication information managing procedure causing the computer to manage authentication information related to the services and having a term of validity;
an extension request accepting procedure causing the computer to accept an extension request to extend the term of validity of the authentication information; and
an authentication information updating procedure causing the computer to extend the term of validity of the authentication information depending on the extension request.

22. A service providing apparatus comprising:
an integrated services providing section to provide integrated services of one or a plurality of services provided by a service providing section,
said integrated services providing section comprising:
a creating request sending section to send an authentication information creating request requesting creation of authentication information which has a term of validity and is related to a service provided by a first service providing section within said service providing section, with respect to the first service providing section;
a response receiving section to receive from the first service providing section an authentication information creation response including an authentication information identifier for identifying the authentication information and the term of validity of the authentication information; and
an extension request sending section to send an extension request requesting extension of the term of validity of the authentication information, with respect to the first service providing section.

23. The service providing apparatus as claimed in claim 22, wherein the extension request includes the authentication information identifier for identifying the authentication information and a requested extension time.

24. The service providing apparatus as claimed in claim 23, wherein the extension request further includes an identifier for identifying the integrated services providing section.

25. The service providing apparatus as claimed in claim 22, wherein said integrated services providing section further comprises an authentication information managing section to manage the authentication information identifier for identifying the authentication information and the term of validity of the authentication information.

26. The service providing apparatus as claimed in claim 22, wherein said integrated services providing section further comprises an extension response receiving section to receive from the first service providing section an extension response including an authentication information identifier for identifying authentication information having an extended term of validity and an extended term of validity.

27. The service providing apparatus as claimed in claim 25, wherein said authentication information managing section further manages an authentication information identifier for identifying authentication information having an extended term of validity and an extended term of validity.

28. The service providing apparatus as claimed in claim 22, wherein said integrated services providing section further comprises a session request sending section to send with respect to a second service providing section within said service providing section, other than the first service providing section, a session request requesting start of a session and including the authentication information identifier for identifying the authentication information.

29. The service providing apparatus as claimed in claim 28, wherein said integrated services providing section further comprises a session response receiving section to receive from the second service providing section a session response indicating the start of the session and including a session identifier for identifying the session.

30. The service providing apparatus as claimed in claim 28, wherein said integrated service providing section further comprises a session managing section to manage a session identifier for identifying the session.

31. The service providing apparatus as claimed in claim 22, wherein said integrated service providing section further comprises a notification receiving section to receive from the first service providing section a term of validity information notification including information related to the term of validity of the authentication information.

32. The service providing apparatus as claimed in claim 22, wherein said integrated service providing section further comprises a monitoring section to monitor the term of validity of the authentication information.

33. A service providing method for an integrated services providing section which provides integrated services of one or a plurality of services provided by a service providing section, comprising:
a creating request sending step to send an authentication information creating request requesting creation of authentication information which has a term of validity and is related to a service provided by a first service providing section within said service providing section, with respect to the first service providing section;
a response receiving step to receive from the first service providing section an authentication information creation response including an authentication information identifier for identifying the authentication information and the term of validity of the authentication information; and
an extension request sending step to send an extension request requesting extension of the term of validity of the authentication information, with respect to the first service providing section.

34. The service providing method as claimed in claim 33, wherein the extension request includes the authentication information identifier for identifying the authentication information and a requested extension time.

35. The service providing method as claimed in claim 34, wherein the extension request further includes an identifier for identifying the integrated services providing section.

36. The service providing method as claimed in claim 33, further comprising:
an authentication information managing step to manage the authentication information identifier for identifying the authentication information and the term of validity of the authentication information.

37. The service providing method as claimed in claim 33, further comprising:
an extension response receiving step to receive from the first service providing section an extension response including an authentication information identifier for identifying authentication information having an extended term of validity and an extended term of validity.

38. The service providing method as claimed in claim 36, wherein said authentication information managing step further manages an authentication information identifier for identifying authentication information having an extended term of validity and an extended term of validity.

39. The service providing method as claimed in claim 33, further comprising:
a session request sending step to send with respect to a second service providing section within said service providing section, other than the first service providing section, a session request requesting start of a session and including the authentication information identifier for identifying the authentication information.

40. The service providing method as claimed in claim 39, further comprising:
a session response receiving step to receive from the second service providing section a session response indicating the start of the session and including a session identifier for identifying the session.

41. The service providing method as claimed in claim 39, further comprising:
a session managing step to manage a session identifier for identifying the session.

42. The service providing method as claimed in claim 33, further comprising:
a notification receiving step to receive from the first service providing section a term of validity information notification including information related to the term of validity of the authentication information.

43. The service providing method as claimed in claim 33, further comprising:
a monitoring step to monitor the term of validity of the authentication information.

44. A computer-readable storage medium which stores a program for causing a computer to provide integrated services of one or a plurality of services provided by a service providing section, comprising:
a creating request sending procedure causing the computer to send an authentication information creating request requesting creation of authentication information which has a term of validity and is related to a service provided by a first service providing section within said service providing section, with respect to the first service providing section;
a response receiving procedure causing the computer to receive from the first service providing section an authentication information creation response including an authentication information identifier for identifying the authentication information and the term of validity of the authentication information; and
an extension request sending procedure causing the computer to send an extension request requesting extension of the term of validity of the authentication information, with respect to the first service providing section.
